(19) United States
(12) Patent Application Publication
(10) Pub. No.: US 2026/0253042 A1
(43) Pub. Date: Aug. 27, 2026

(54) SYSTEM

(71) Applicant: SoftBank Group Corp., Tokyo (JP)

(72) Inventor: Jumpei KASAHARA, Tokyo (JP)

(73) Assignee: SoftBank Group Corp., Tokyo (JP)

(21) Appl. No.: 19/534,920

(22) Filed: Feb. 10, 2026

(30) Foreign Application Priority Data
Feb. 21, 2025 (JP) 2025-027014

(51) Int. Cl. G06Q 10/109; G06F 40/40; G06V 10/44; G06V 10/75; G06V 10/764; G06V 10/82; G06V 10/94; G06V 20/50

(52) U.S. Cl. CPC G06Q 10/1097; G06F 40/40; G06V 10/44; G06V 10/751; G06V 10/764; G06V 10/82; G06V 10/95; G06V 20/50

(57) ABSTRACT

The system according to the embodiment comprises a reception unit, a generation unit, a listing unit, a quotation acquisition unit, and an image recognition unit. The reception unit is configured to receive input of a user's new address or desired move-in date. The generation unit is configured to generate a schedule based on information received by the reception unit. The listing unit is configured to allow the user to take photographs of items to be sold, set an appropriate price by uploading them to a generation algorithm, and list them in a flea market. The quotation acquisition unit is configured to estimate the amount of moving luggage when the user inputs the quantity and obtain quotations from multiple moving companies. The image recognition unit is configured to determine, using image recognition technology, whether furniture is compatible when the user uploads a floor plan of the new residence and photographs of furniture.

### CROSS-REFERENCE TO RELATED APPLICATION

The present application claims priority to and incorporates by reference the entire contents of Japanese Patent Application No. 2025-027014 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, it has been difficult to efficiently carry out various procedures related to moving, resulting in problems of requiring significant time and effort.

### SUMMARY OF THE INVENTION

The system according to the embodiment comprises a reception unit, a generation unit, a listing unit, a quotation acquisition unit, and an image recognition unit. The reception unit is configured to receive input of a user's new address or desired move-in date. The generation unit is configured to generate a schedule based on information received by the reception unit. The listing unit is configured to allow the user to take photographs of items to be sold, set an appropriate price by uploading them to a generation algorithm, and list them in a flea market. The quotation acquisition unit is configured to estimate the amount of moving luggage when the user inputs the quantity and obtain quotations from multiple moving companies. The image recognition unit is configured to determine, using image recognition technology, whether furniture is compatible when the user uploads a floor plan of the new residence and photographs of furniture.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5 th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

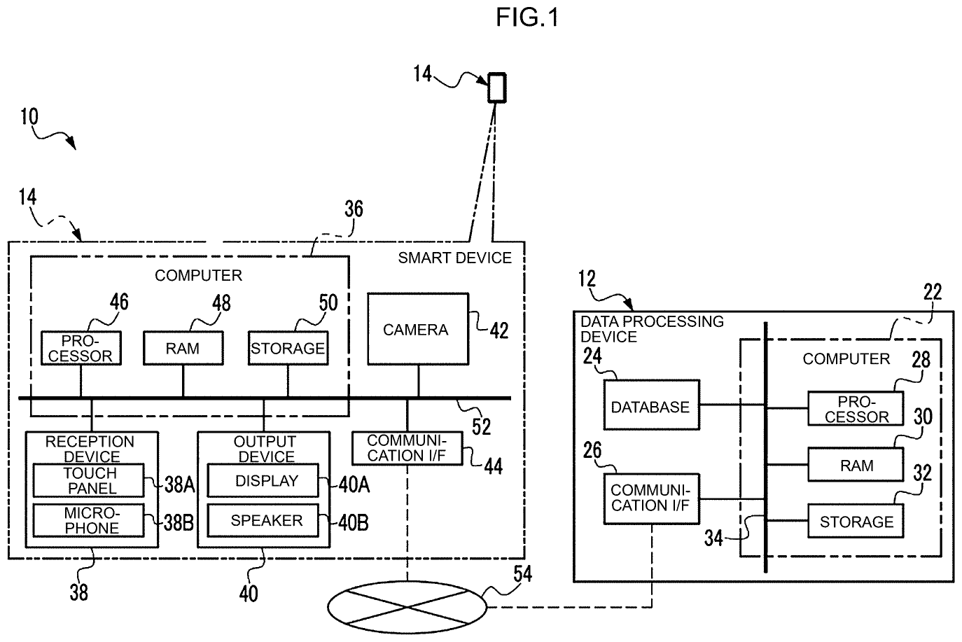

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

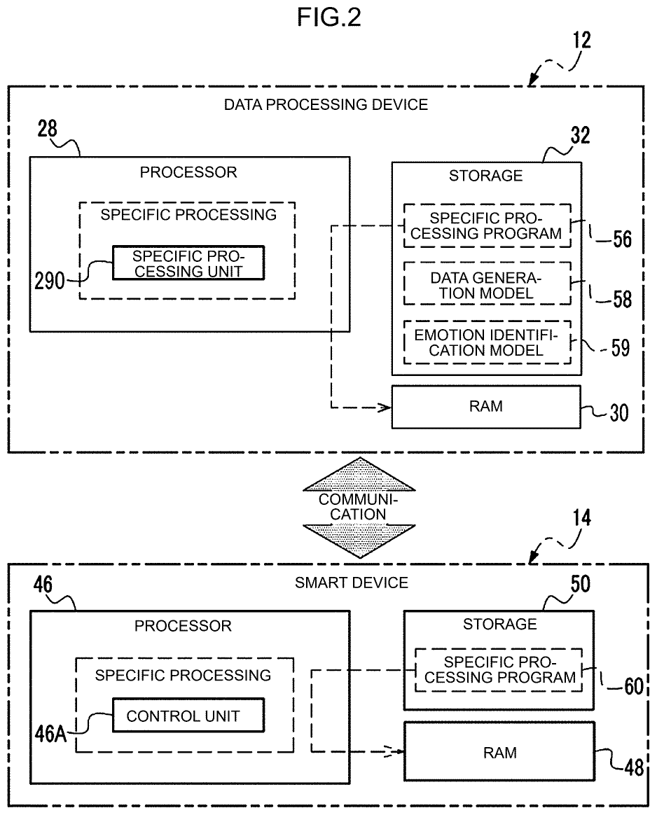

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example of the Embodiment

The moving support system according to the embodiment of the present invention is a system that utilizes generative AI to shorten the time required for a mover's relocation and reduce the hassle associated with moving. This moving support system automatically creates an optimal schedule in tabular format using generative AI when the user inputs the new address or desired move-in date, thereby facilitating smooth progress of the moving plan. In addition, the system provides an automatic flea market listing function for disposing of unnecessary items. When the user takes photographs of items to be sold and uploads them to the generative AI, the AI automatically sets an appropriate price and lists the items in the flea market, enabling easy disposal of unnecessary items and contributing to waste reduction. Furthermore, the system provides a function to obtain quotations from moving companies. When the user inputs the amount of moving luggage, the generative AI estimates the quantity and obtains quotations from multiple moving companies, allowing the user to select the optimal moving company. Finally, the system provides a function to determine, using image recognition technology, whether furniture is compatible with the floor plan of the new residence. When the user uploads the floor plan and photographs of furniture, the generative AI uses image recognition technology to determine compatibility and provides appropriate advice if the furniture is not compatible, thereby enabling smooth arrangement of furniture after moving. Thus, the present invention aims to streamline various procedures related to moving and reduce the burden on movers. As a result, the moving support system can shorten the time required for moving and reduce the hassle associated with moving. Specifically, the moving support system adopts a configuration in which multiple AI modules (schedule generation AI, price estimation AI, quotation acquisition AI, image recognition AI) operate in coordination. The system accepts input data from the user, such as address information (string data, e.g., “1-2-3 Shinjuku-ku, Tokyo”), desired move-in date (date data in ISO8601 format, e.g., “2024-07-01”), item images (RGB image tensor, 224×224×3), item descriptions (text data), luggage list (structured data in JSON format, e.g., {“item”:“refrigerator”,“weight”:50,“volume”:0.5}), floor plan images (grayscale or color image tensor, 512×512×1 or 3), and furniture images (similar image tensors). The schedule generation AI uses a Transformer-based large language model to tokenize user input information, prioritize tasks, and adjust schedules, generating schedule data in tabular format (CSV or JSON array, e.g., {“task”:“packing”,“date”:“2024-06-25”}) as output. The price estimation AI combines image feature extraction (CNN such as ResNet) and text feature extraction (encoder such as BERT) to generate multimodal feature vectors (e.g., 512 dimensions) and outputs a price score (real value, e.g., 3500 yen) via a fully connected layer. The quotation acquisition AI takes the luggage list data as input, vectorizes the weight, volume, and category of each item, inputs them into the pricing models of multiple companies (linear regression or decision tree regression), and outputs quotation amounts (e.g., {“Company A”: 12000, “Company B”:15000}). The image recognition AI extracts features from the floor plan and furniture images using CNNs, performs spatial alignment (image registration algorithms or IoU calculation), and generates compatibility judgments (binary label: compatible/incompatible) and advice sentences (e.g., “The width of the sofa exceeds the width of the passageway”). These AI outputs are presented on the user interface in tabular, graphical, or textual advice formats. The AI output values are used in subsequent processing such as threshold judgment (e.g., whether the price is within ±20% of the market median), branching (advice generation only if compatibility judgment is negative), and external API integration (sending quotation results to the company selection module). As a technical effect, the system greatly accelerates, improves the accuracy of, and reduces errors in the previously labor-intensive processes of information gathering, schedule adjustment, price negotiation, and furniture arrangement by means of high-dimensional feature extraction, rule-based processing, and automatic optimization using AI. In particular, data flow optimization through coordination of multiple AI modules (e.g., using schedule generation results as input for the quotation acquisition AI) and integration of multimodal input processing (image+text+numerical data) enable complex judgments and recommendations that were difficult with conventional single-modal processing. Application fields include support for moving for individuals, families, and companies, automatic listing of reused items, furniture arrangement simulation, and support for selecting moving companies. Thus, the present invention achieves not only operational efficiency but also technical advancement in the processing capability, autonomy, and quality of user experience of computer systems utilizing AI technology.

The moving support system according to the embodiment comprises a reception unit, a generation unit, a listing unit, a quotation acquisition unit, and an image recognition unit. The reception unit is configured to receive input of the user's new address and desired move-in date. The user's new address may include, for example, postal code, building name, and room number, but is not limited thereto. The desired move-in date may be input in date format or time zone, for example. The generation unit is configured to generate a schedule based on information received by the reception unit. Schedule generation may be performed based on task priority and time allocation, for example, but is not limited thereto. The listing unit is configured to allow the user to take photographs of items to be sold, upload them to the generative AI to set an appropriate price, and list them in a flea market. The appropriate price may be calculated based on market price or supply-demand balance, for example, but is not limited thereto. The quotation acquisition unit is configured to estimate the amount of moving luggage when the user inputs the quantity and obtain quotations from multiple moving companies. The estimation of quantity may be performed based on item type, weight, and volume, for example, but is not limited thereto. The image recognition unit is configured to determine, using image recognition technology, whether furniture is compatible when the user uploads a floor plan of the new residence and photographs of furniture. The image recognition technology may be implemented by object detection or image classification, for example, but is not limited thereto. Thus, the moving support system according to the embodiment can streamline various procedures related to moving and reduce the burden on movers. Specifically, the moving support system implements the functions of each unit as AI modules. The reception unit accepts input data from the user (e.g., address information as UTF-8 encoded string, desired move-in date as date data in ISO8601 format, e.g., “2024-07-01”). The generation unit uses a Transformer-based large language model to tokenize information received from the reception unit, prioritize tasks, and adjust schedules, generating schedule data in CSV or JSON array format (e.g., {“task”:“packing”,“date”:“2024-06-25”}) as output. The listing unit extracts multimodal features from item images uploaded by the user (RGB image tensor, 224×224×3) and item descriptions (text data) using CNN and BERT encoders, outputs a price score (real value, e.g., 3500 yen) via a fully connected layer, and automates listing by linking with the flea market API. The quotation acquisition unit takes the luggage list (JSON format, e.g., {“item”:“refrigerator”,“weight”:50,“volume”:0.5}) as input, vectorizes the features of each item, inputs them into the pricing models of multiple companies (linear regression or decision tree regression), and outputs quotation amounts (e.g., {“Company A”: 12000, “Company B”:15000}). The image recognition unit extracts features from the floor plan image (512×512×1 or 3) and furniture image (similar image tensor) using CNNs, performs spatial alignment (image registration algorithms or IoU calculation), and generates compatibility judgments (binary label: compatible/incompatible) and advice sentences (e.g., “The width of the sofa exceeds the width of the passageway”). The AI output values are used in subsequent processing such as threshold judgment (e.g., whether the price is within ±20% of the market median), branching (advice generation only if compatibility judgment is negative), and external API integration (sending quotation results to the company selection module). As a technical effect, the system greatly accelerates, improves the accuracy of, and reduces errors in the previously labor-intensive processes of information gathering, schedule adjustment, price negotiation, and furniture arrangement by means of high-dimensional feature extraction, rule-based processing, and automatic optimization using AI. In particular, data flow optimization through coordination of multiple AI modules and integration of multimodal input processing (image+text+numerical data) enable complex judgments and recommendations that were difficult with conventional single-modal processing. Application fields include support for moving for individuals, families, and companies, automatic listing of reused items, furniture arrangement simulation, and support for selecting moving companies. Thus, the present invention achieves not only operational efficiency but also technical advancement in the processing capability, autonomy, and quality of user experience of computer systems utilizing AI technology.

The reception unit is configured to estimate the user's emotions and adjust the timing of input of the new address or desired move-in date based on the estimated emotions of the user. For example, if the user is feeling stressed, the reception unit may delay the input timing to provide time for relaxation. If the user is in a hurry, the reception unit may advance the input timing to quickly collect information. Furthermore, if the user is relaxed, the reception unit may set the input timing as usual. By adjusting the input timing according to the user's emotions, the burden on the user can be reduced. Emotion estimation may be implemented using an emotion engine or generative AI, for example. The generative AI may be a text generation AI (e.g., LLM) or a multimodal generative AI, but is not limited thereto. Some or all of the above-described processing in the reception unit may be performed using AI or without using AI. For example, the reception unit may input the user's facial expression data to the generative AI and have the AI perform emotion estimation. Specifically, the reception unit may input the user's facial expression image (RGB image tensor, 224×224×3), audio data (WAV format, 16 kHz, 1 ch), and input text (UTF-8 string, e.g., “I am busy today”) to the AI module. The AI module extracts image and audio features using CNN and RNN, and text features using an encoder such as BERT. These features are integrated, and the fully connected layer outputs emotion labels (e.g., stress, relaxation, urgency) and emotion scores (real values from 0.0 to 1.0, e.g., stress 0.85). The AI output values are passed to the input timing control module, which performs branching processing such as delaying input acceptance if the emotion score is high, or accepting input immediately if urgency is detected. As a technical effect, the reception unit can estimate the user's psychological state in real time and prompt information input at the optimal timing for each user, unlike conventional uniform input acceptance, thereby improving user experience, reducing input errors, and enhancing overall system responsiveness. Application fields include not only moving support, but also customer support reception, medical interview reception, and learning progress management in education, as well as any system requiring interaction according to user state.

The reception unit is configured to analyze the user's past moving history and select an optimal input method. For example, the reception unit may preferentially suggest input methods (such as voice or text) that the user has used in the past. The reception unit may also automatically complete input items by referring to information previously entered by the user. Furthermore, the reception unit may extract specific patterns from the user's past moving history and propose the optimal input method. By analyzing the user's past moving history, the optimal input method can be provided. Some or all of the above-described processing in the reception unit may be performed using AI or without using AI. For example, the reception unit may input the user's past moving data to the generative AI and have the AI select the optimal input method. Specifically, the reception unit may input the user's past moving history data (JSON format, e.g., {“date”:“2022-03-01”,“method”:“voice”,“items”: [“refrigerator”“washing machine”]}), device information at the time of input (e.g., smartphone, PC), and time required to complete input (numerical data, e.g., 120 seconds) to the AI module. The AI module vectorizes features such as past input methods and their efficiency (required time, error rate), and uses algorithms such as decision trees or random forests to estimate the optimal input method (e.g., voice input, text input, image upload). The AI output values are passed to the UI control module of the reception unit and used for subsequent processing such as suggesting the estimated optimal input method to the user or displaying automatic completion candidates. As a technical effect, the reception unit can provide personalized input support based on each user's past data, which cannot be achieved with conventional uniform input interfaces, thereby improving input efficiency, reducing input errors, and enhancing user satisfaction. Application fields include not only moving support, but also insurance applications, financial service applications, medical interviews, and any system requiring input optimization based on past history.

The reception unit is configured to perform filtering based on the user's current living situation or areas of interest when inputting the new address or desired move-in date. For example, if the user has a pet, the reception unit may preferentially display pet-friendly properties. If the user values commuting time, the reception unit may preferentially display properties with short commuting times. Furthermore, if the user desires a specific school district, the reception unit may preferentially display properties within that school district. By performing filtering based on the user's living situation or areas of interest, more appropriate information can be provided. Some or all of the above-described processing in the reception unit may be performed using AI or without using AI. For example, the reception unit may input the user's living situation data to the generative AI and have the AI perform filtering. Specifically, the reception unit may input the user's living situation data (JSON format, e.g., {“pets”: true,“commute_time”:30,“school_zone”:“District A”}), areas of interest (category labels, e.g., “pet-friendly”, “commute-focused”), and past property selection history (list format) to the AI module. The AI module vectorizes these features and uses neural networks or gradient boosting trees to score property candidates and output filtering results (e.g., list of pet-friendly property IDs, list of properties within 30 minutes commute). The AI output values are passed to the property display module and used for subsequent processing to preferentially display only properties that match the user's interests. As a technical effect, the reception unit can analyze the user's diverse living situations and areas of interest in a high-dimensional feature space and automate complex filtering that was difficult with conventional simple condition searches, thereby improving information search efficiency, user satisfaction, and reducing incorrect selections. Application fields include not only housing search, but also job matching, product recommendation, course selection in education, and any system requiring information filtering according to individual needs.

The reception unit is configured to estimate the user's emotions and determine the priority of information to be input based on the estimated emotions of the user. For example, if the user is feeling stressed, the reception unit may prioritize input of important information and postpone detailed information. If the user is relaxed, the reception unit may prioritize input of detailed information. Furthermore, if the user is in a hurry, the reception unit may prioritize input of minimal information. By determining the priority of information to be input according to the user's emotions, the burden on the user can be reduced. Emotion estimation may be implemented using an emotion engine or generative AI, for example. The generative AI may be a text generation AI (e.g., LLM) or a multimodal generative AI, but is not limited thereto. Some or all of the above-described processing in the reception unit may be performed using AI or without using AI. For example, the reception unit may input the user's facial expression data to the generative AI and have the AI perform emotion estimation. Specifically, the reception unit may input the user's facial expression image (RGB image tensor, 224×224×3), audio data (WAV format), and input text (UTF-8 string) to the AI module. The AI module extracts image and audio features using CNN and RNN, and text features using BERT, and the fully connected layer outputs emotion labels (e.g., stress, relaxation, urgency) and emotion scores (e.g., stress 0.8). The AI output values are passed to the input item priority control module, which performs branching processing such as displaying main items (e.g., address, move-in date) first and postponing detailed items (e.g., desired facilities) according to the emotion score. As a technical effect, the reception unit can estimate the user's psychological state in real time and minimize user burden and maximize input efficiency, which cannot be achieved with conventional uniform input order. Application fields include not only moving support, but also medical interviews, financial applications, learning progress management in education, and any system requiring input control according to user state.

The reception unit is configured to preferentially input highly relevant information based on the user's geographic location information when inputting the new address or desired move-in date. For example, the reception unit may preferentially display properties close to the user's current location. The reception unit may also propose optimal move-in dates considering travel time from the user's current location. Furthermore, the reception unit may prioritize input of highly relevant information based on the distance from the user's current location. By considering the user's geographic location information, highly relevant information can be preferentially provided. Some or all of the above-described processing in the reception unit may be performed using AI or without using AI. For example, the reception unit may input the user's geographic location data to the generative AI and have the AI select highly relevant information. Specifically, the reception unit may input the user's current location information (GPS coordinate data, e.g., latitude 35.6895, longitude 139.6917), means of transportation (e.g., walking, train, car), and past travel history (time series array) to the AI module. The AI module uses geographic distance calculation algorithms and time series analysis (e.g., LSTM) to calculate distances and travel times to candidate properties and outputs relevance scores (e.g., 0.95). The AI output values are passed to the property display module or move-in date proposal module and used for subsequent processing to preferentially display highly relevant properties or optimal move-in dates. As a technical effect, the reception unit can analyze the user's geographic situation with high precision and automate information recommendation based on travel convenience and living area, which was difficult with conventional simple area searches, thereby improving user satisfaction, speeding up decision-making, and reducing incorrect selections. Application fields include not only real estate search, but also tourist guidance, logistics delivery planning, disaster evacuation support, and any system requiring information recommendation utilizing geographic information.

The reception unit is configured to analyze the user's social media activity and input related information when inputting the new address or desired move-in date. For example, the reception unit may automatically input information about the new address shared by the user on social media. The reception unit may also preferentially display properties in areas followed by the user on social media. Furthermore, the reception unit may identify areas of interest from the user's social media activity and input related information. By analyzing the user's social media activity, related information can be provided. Some or all of the above-described processing in the reception unit may be performed using AI or without using AI. For example, the reception unit may input the user's social media data to the generative AI and have the AI select related information. Specifically, the reception unit may input the user's social media post data (JSON format, e.g., {“post”:“I want to move to Shinjuku-ku”,“date”:“2024-05-01”}), followed area information (list format, e.g., “Shibuya-ku”, “Nakano-ku”), and like history (time series array) to the AI module. The AI module uses natural language processing (e.g., BERT) to extract area interest from post content and uses clustering or frequency analysis to identify areas of interest. The AI output values are passed to the property candidate list or input completion module and used for subsequent processing to preferentially display properties in areas of interest or automatically input post content. As a technical effect, the reception unit can analyze the user's online behavior in a high-dimensional feature space and realize automatic extraction of latent interests and information recommendation, which was difficult with conventional manual input or simple history reference. Application fields include not only housing search, but also job recommendation, product recommendation, event guidance, and any system requiring personalized information provision utilizing social data.

The generation unit is configured to estimate the user's emotions and adjust the schedule generation method based on the estimated emotions of the user. For example, if the user is feeling stressed, the generation unit may simplify the schedule and display only important tasks. If the user is relaxed, the generation unit may generate a detailed schedule and display fine-grained tasks. Furthermore, if the user is in a hurry, the generation unit may generate a schedule that can be completed in the shortest possible time. By adjusting the schedule generation method according to the user's emotions, the burden on the user can be reduced. Emotion estimation may be implemented using an emotion engine or generative AI, for example. The generative AI may be a text generation AI (e.g., LLM) or a multimodal generative AI, but is not limited thereto. Some or all of the above-described processing in the generation unit may be performed using AI or without using AI. For example, the generation unit may input the user's facial expression data to the generative AI and have the AI perform emotion estimation. Specifically, the generation unit may input the user's facial expression image (RGB image tensor, 224×224×3), audio data (WAV format, 16 kHz, 1 ch), and input text (UTF-8 string, e.g., “I am busy today”) to the emotion estimation AI module. The emotion estimation AI module extracts facial features from the expression image using CNN, extracts acoustic features (e.g., mel spectrogram, pitch, energy) from the audio waveform using RNN or Transformer encoder, and extracts text features using a language model such as BERT. These features are integrated using a multilayer perceptron, and emotion labels (e.g., stress, relaxation, urgency) and emotion scores (real values from 0.0 to 1.0, e.g., stress 0.85) are output. The generation unit inputs the output values of the emotion estimation AI to the schedule generation AI, which uses a Transformer-based large language model to switch schedule generation policies according to the user's emotional state. For example, if the stress score is high, the schedule generation AI extracts only main tasks such as “packing” and “moving procedures” and outputs a simplified schedule in tabular format (CSV or JSON array, e.g., {“task”:“packing”,“date”:“2024-06-25”}). In a relaxed state, the schedule is broken down into subtasks (e.g., packing for each room, mail forwarding procedures, internet cancellation, etc.) and detailed schedules with attributes such as date, person in charge, and required time are generated. In a hurry, the required time for all tasks is estimated, and the shortest completion order is determined using shortest path search algorithms (e.g., Dijkstra's algorithm or A* search), and only high-priority tasks are extracted and output. The AI output values are presented on the user interface in tabular or Gantt chart format, allowing the user to immediately check a schedule optimized for their emotional state. In subsequent processing, the schedule generation results are also used as input for reminder notification modules or moving company quotation acquisition AI. As a technical effect, the generation unit can analyze the user's psychological state in a high-dimensional feature space in real time and realize personalized plan presentation, which was difficult with conventional uniform schedule generation, thereby improving user experience, reducing input errors and planning delays, and enhancing overall system responsiveness. Application fields include not only moving support, but also project management, medical scheduling, learning plan generation in education, and any system requiring dynamic schedule generation according to user state.

The generation unit is configured to adjust the level of detail of the schedule based on the importance of the move when generating the schedule. For example, the generation unit may set a detailed schedule for important moving tasks and display fine-grained tasks. For tasks of low importance, the generation unit may set a simplified schedule and display only main tasks. Furthermore, the generation unit may dynamically adjust the level of detail of the schedule according to the importance of the move. By adjusting the level of detail of the schedule based on the importance of the move, the burden on the user can be reduced. Some or all of the above-described processing in the generation unit may be performed using AI or without using AI. For example, the generation unit may input the importance data of moving tasks to the generative AI and have the AI adjust the level of detail of the schedule. Specifically, the generation unit may input the importance data of moving tasks assigned by the user or system (numerical score or category label, e.g., {“task”:“packing”,“importance”:0.95}) to the schedule generation AI. The schedule generation AI uses a Transformer-based large language model to control the level of detail of the schedule according to the importance score of each task. For example, for tasks with importance of 0.8 or higher, the schedule generation AI automatically generates detailed information such as subtask breakdown (e.g., “packing the refrigerator”, “draining the washing machine”), assignment of person in charge, estimation of required time, and generation of necessary materials list, and outputs in CSV or JSON array format. For tasks with importance less than 0.5, only the main task name and scheduled date are displayed in a simplified manner, and detailed information is omitted. AI output examples include detailed schedule: {“task”:“packing”,“subtasks”: [“packing refrigerator”,“draining washing machine”],“date”:“2024-06-25”,“person”:“self”,“duration”: 120}, and simplified schedule: {“task”:“mail forwarding procedure”,“date”:“2024-06-28”}. The output values of the schedule generation AI are passed to a module that automatically switches between detailed and simplified display on the user interface, allowing the user to select the granularity of the schedule according to their needs. In subsequent processing, detailed schedules are used for reminder notifications or as input for progress management AI, while simplified schedules are used for overview display of the overall plan. As a technical effect, the generation unit realizes control of schedule detail level in a high-dimensional feature space based on task importance, thereby minimizing user burden and improving planning accuracy, which was difficult with conventional uniform schedule presentation. Application fields include not only moving support, but also project management, manufacturing process planning, medical surgery scheduling, and any system requiring dynamic schedule generation according to task importance.

The generation unit is configured to apply different generation algorithms according to the category of the move when generating the schedule. For example, in the case of a family move, the generation unit applies an algorithm that considers the schedules of all family members. In the case of a single-person move, the generation unit applies an algorithm optimized for the individual's schedule. Furthermore, in the case of a corporate move, the generation unit applies an algorithm that integrates the schedules of multiple departments. By applying different generation algorithms according to the category of the move, the burden on the user can be reduced. Some or all of the above-described processing in the generation unit may be performed using AI or without using AI. For example, the generation unit may input moving category data to the generative AI and have the AI apply the generation algorithm. Specifically, the generation unit may input moving category data selected by the user (e.g., {“category”:“family”}, {“category”:“single”}, {“category”:“corporate”}) to the schedule generation AI. The schedule generation AI has different algorithm modules for each category. For family moves, it integrates calendar information for multiple users (JSON array, e.g., {“person”:“father”,“available_dates”: [“2024-06-25”,“2024-06-26”]}), children's school schedules, and the luggage list for all family members, and uses a constraint satisfaction problem (CSP) solver or multi-objective optimization algorithm (e.g., NSGA-II) to generate a schedule that maximizes convenience for all. For single-person moves, the individual's schedule and desired dates are prioritized, and simple priority-based task scheduling (e.g., assigning tasks in order of priority) is performed. For corporate moves, business calendars for multiple departments, equipment relocation schedules, and IT infrastructure switch dates are integrated, and project management AI (e.g., Gantt chart generation AI or PERT analysis AI) is used for overall optimization. The AI output values are presented on the user interface in different schedule structures for each category (e.g., individual task lists for family moves, department-based Gantt charts for corporate moves). In subsequent processing, family moves use the schedule for family coordination notifications, and corporate moves use it as input for inter-departmental coordination AI. As a technical effect, the generation unit automates selection of optimized algorithms for each category, thereby achieving planning optimization and reduction of user burden under complex constraints, which was difficult with conventional uniform schedule generation. Application fields include not only moving support, but also event management, simultaneous management of multiple projects, timetable creation for educational institutions, and any system requiring category-specific scheduling.

The generation unit is configured to estimate the user's emotions and adjust the length of the schedule based on the estimated emotions of the user. For example, if the user is feeling stressed, the generation unit may shorten the schedule and display only important tasks. If the user is relaxed, the generation unit may extend the schedule and display detailed tasks. Furthermore, if the user is in a hurry, the generation unit may set the schedule length to the shortest possible and enable rapid completion. By adjusting the length of the schedule according to the user's emotions, the burden on the user can be reduced. Emotion estimation may be implemented using an emotion engine or generative AI, for example. The generative AI may be a text generation AI (e.g., LLM) or a multimodal generative AI, but is not limited thereto. Some or all of the above-described processing in the generation unit may be performed using AI or without using AI. For example, the generation unit may input the user's facial expression data to the generative AI and have the AI perform emotion estimation. Specifically, the generation unit may input the user's facial expression image (RGB image tensor, 224×224×3), audio data (WAV format, 16 kHz, 1 ch), and input text (UTF-8 string) to the emotion estimation AI module. The emotion estimation AI module extracts image and audio features using CNN and RNN, and text features using BERT, and the fully connected layer outputs emotion labels (e.g., stress, relaxation, urgency) and emotion scores (e.g., stress 0.8). The generation unit inputs the emotion score to the schedule generation AI, which, if the stress score is high, limits the total number of tasks (e.g., displays only 3 tasks), in a relaxed state, displays all tasks in detail, and in a hurry, extracts the minimum task set using shortest path search. The AI output values are visualized on the user interface as the length of the schedule (number of tasks or duration), allowing the user to immediately check a plan optimized for their state. In subsequent processing, shortened schedules are used for optimization of reminder and notification frequency, and detailed schedules are used as input for progress management AI. As a technical effect, the generation unit realizes schedule length control according to the user's psychological state in a high-dimensional feature space, thereby minimizing user burden and improving planning accuracy, which was difficult with conventional uniform plan presentation. Application fields include not only moving support, but also project management, medical scheduling, learning plan generation in education, and any system requiring dynamic schedule length control according to user state.

The generation unit is configured to determine the priority of the schedule based on the submission timing of the move when generating the schedule. For example, the generation unit may preferentially incorporate tasks with imminent deadlines into the schedule. Tasks with distant deadlines may be postponed and incorporated into the schedule later. Furthermore, the generation unit may dynamically adjust the priority of the schedule based on the submission timing. By determining the priority of the schedule based on the submission timing of the move, the burden on the user can be reduced. Some or all of the above-described processing in the generation unit may be performed using AI or without using AI. For example, the generation unit may input move submission timing data to the generative AI and have the AI determine the priority of the schedule. Specifically, the generation unit may input submission deadline data for each task (date in ISO8601 format, e.g., {“task”:“submit moving notification”,“deadline”:“2024-06-28”}) to the schedule generation AI. The schedule generation AI uses a Transformer-based large language model to sort all task deadlines in chronological order and assign priority in order of proximity. Priority scores (e.g., 1.0 to 0.0) are assigned to each task, and tasks with higher priority are incorporated into the schedule first. AI output examples include {“task”:“submit moving notification”,“priority”:0.95,“date”:“2024-06-25”}, {“task”:“cancel internet”,“priority”:0.60,“date”:“2024-06-28”}. The output values of the schedule generation AI are passed to a module that displays tasks in order of priority on the user interface, allowing the user to plan without missing deadlines. In subsequent processing, high-priority tasks are used to increase reminder notification frequency, and low-priority tasks are postponed, among other branching processes. As a technical effect, the generation unit automates priority control based on submission timing in a high-dimensional feature space, thereby achieving deadline compliance and planning optimization, which was difficult with conventional manual management. Application fields include not only moving support, but also project deadline management, medical examination scheduling, assignment submission management in education, and any system requiring deadline-based priority control.

The generation unit is configured to adjust the order of the schedule based on the relevance of the move when generating the schedule. For example, the generation unit may preferentially incorporate highly relevant tasks into the schedule. Tasks with low relevance may be postponed and incorporated into the schedule later. Furthermore, the generation unit may dynamically adjust the order of the schedule based on the relevance of the move. By adjusting the order of the schedule based on the relevance of the move, the burden on the user can be reduced. Some or all of the above-described processing in the generation unit may be performed using AI or without using AI. For example, the generation unit may input move relevance data to the generative AI and have the AI adjust the order of the schedule. Specifically, the generation unit may input relevance data between tasks (graph structure, e.g., {“taskA”:“packing”,“taskB”:“submit moving notification”,“relation”:0.8}) to the schedule generation AI. The schedule generation AI uses a graph neural network (GNN) or Transformer-based model to analyze dependencies and relevance scores between tasks. Tasks with high relevance are placed consecutively in the schedule, while tasks with low relevance are postponed. AI output examples include {“task”:“packing”,“order”: 1}, {“task”:“submit moving notification”,“order”:2}, {“task”:“cancel internet”,“order”:3}. The output values of the schedule generation AI are passed to a module that displays tasks in order of relevance on the user interface, allowing the user to grasp an efficient work sequence. In subsequent processing, highly relevant tasks are grouped or notified simultaneously, while tasks with low relevance are split into separate schedules. As a technical effect, the generation unit automates order optimization based on task relevance in a high-dimensional feature space, thereby improving work efficiency and planning accuracy, which was difficult with conventional manual reordering. Application fields include not only moving support, but also manufacturing process management, project task management, medical procedure order optimization, and any system requiring order control based on task relevance.

The listing unit is configured to estimate the user's emotions and adjust the method of expressing the listing based on the estimated emotions of the user. For example, if the user is feeling stressed, the listing unit provides a simple expression method and simplifies the listing procedure. If the user is relaxed, the listing unit provides a detailed expression method and proposes a customizable listing method. Furthermore, if the user is in a hurry, the listing unit enables completion of the listing with minimal information for rapid listing. By adjusting the method of expressing the listing according to the user's emotions, the burden on the user can be reduced. Emotion estimation may be implemented using an emotion engine or generative AI, for example. The generative AI may be a text generation AI (e.g., LLM) or a multimodal generative AI, but is not limited thereto. Some or all of the above-described processing in the listing unit may be performed using AI or without using AI. For example, the listing unit may input the user's facial expression data to the generative AI and have the AI perform emotion estimation. Specifically, the listing unit may input the user's facial expression image (RGB image tensor, 224×224×3), audio data (WAV format, 16 kHz, 1 ch), and input text (UTF-8 string, e.g., “I am busy today”) to the emotion estimation AI module. The emotion estimation AI module extracts facial features from the expression image using CNN, acoustic features from the audio waveform using RNN or Transformer encoder, and text features using a language model such as BERT. These features are integrated using a multilayer perceptron, and emotion labels (e.g., stress, relaxation, urgency) and emotion scores (real values from 0.0 to 1.0, e.g., stress 0.85) are output. The listing unit inputs the output values of the emotion estimation AI to the listing expression control AI, which, if the stress score is high, templates the listing description, limits input items to the minimum (e.g., product name, price, category only), and generates a UI for one-click listing completion. In a relaxed state, detailed description generation (e.g., product features, usage history, accessories, purchase date), custom tag assignment, increased number of photos, and layout selection are enabled. In a hurry, past listing history or templates for similar products are automatically applied, and a flow for listing completion in as few as two steps is presented. AI output examples include simple listing: “Product name: chair, price: 2000 yen, category: furniture”; detailed listing: “Product name: chair, price: 2000 yen, category: furniture, description: wooden, width 50 cm, purchased 2 years ago, no noticeable scratches, 5 photos”. The output values of the listing expression control AI are reflected in the number of items in the listing form, description length, and photo count restrictions on the user interface. In subsequent processing, the listing content is sent to the flea market API and used as input for automatic price adjustment AI and listing completion notifications. As a technical effect, the listing unit can analyze the user's psychological state in a high-dimensional feature space in real time and realize a personalized listing experience, which was difficult with conventional uniform listing UIs, thereby improving user experience, reducing input errors and listing abandonment, and enhancing overall system responsiveness. Application fields include not only listing of reused items, but also job posting, event announcement creation, product review submission, and any system requiring expression control according to user state.

The listing unit is configured to adjust the level of detail of the listing based on the importance of the item when listing. For example, for important items, the listing unit adds detailed descriptions and includes more photos. For items of low importance, the listing unit adds simplified descriptions and includes fewer photos. Furthermore, the listing unit may dynamically adjust the level of detail of the listing according to the importance of the item. By adjusting the level of detail of the listing based on the importance of the item, the burden on the user can be reduced. Some or all of the above-described processing in the listing unit may be performed using AI or without using AI. For example, the listing unit may input item importance data to the generative AI and have the AI adjust the level of detail of the listing. Specifically, the listing unit may input item importance data assigned by the user or system (numerical score or category label, e.g., {“item”:“luxury watch”,“importance”:0.95}) to the listing detail control AI module. The listing detail control AI module dynamically determines the length of the listing description, number of photos, and presence of additional information items (e.g., accessories, purchase date, warranty, usage history) according to the input importance score. For items with importance of 0.8 or higher, the AI automatically generates a description of at least 500 characters, at least 5 photos, and mandatory detailed specifications and accessory lists, and outputs data in JSON format (e.g., {“item”:“luxury watch”,“description”:“Purchased in 2022, complete accessories, no noticeable scratches”}) and image file lists. For items with importance less than 0.5, the AI recommends a simple description (within 100 characters) with only product name, price, and category, and only one photo, and limits the number of input items in the listing form to the minimum. The AI output values are reflected in the number of items in the listing form, description length, and photo count restrictions on the user interface, allowing the user to obtain the optimal listing experience according to importance. In subsequent processing, detailed listing data is used as input for the flea market API and price estimation AI, while simplified listing data is used for immediate listing or batch listing mode. As a technical effect, the listing unit realizes control of listing detail level in a high-dimensional feature space based on item importance, thereby minimizing user burden and improving the quality of listing information, which was difficult with conventional uniform listing UIs. In particular, automatic detail adjustment by AI reduces trouble due to misdescription or lack of information for important items and improves listing efficiency and contract rate. Application fields include not only listing of reused items, but also job posting, event announcement creation, product review submission, and any system requiring expression control according to information importance.

The listing unit is configured to apply different listing algorithms according to the category of the item when listing. For example, for furniture listings, the listing unit applies an algorithm that adds detailed information such as size and material. For electrical appliance listings, the listing unit applies an algorithm that adds product specifications and warranty information. Furthermore, for clothing listings, the listing unit applies an algorithm that adds size and brand information. By applying different listing algorithms according to the category of the item, the burden on the user can be reduced. Some or all of the above-described processing in the listing unit may be performed using AI or without using AI. For example, the listing unit may input item category data to the generative AI and have the AI apply the listing algorithm. Specifically, the listing unit may input item category data selected by the user (e.g., {“category”:“furniture”}, {“category”:“electrical appliances”}, {“category”:“clothing”}) to the category-specific listing AI module. The category-specific listing AI module has different description item templates and image analysis algorithms for each category. For furniture, the AI automatically generates mandatory items such as dimensions (width, depth, height), material (wood, metal, etc.), assembly status, and delivery route information. For electrical appliances, the AI extracts and generates model number, power consumption, year of manufacture, warranty period, and accessory list. For clothing, the AI automatically incorporates size (S/M/L, etc.), brand name, material, number of times worn, and washing instructions into the description. The AI uses image recognition (e.g., CNN) to extract category-specific features from item images (e.g., leg shape for furniture, tag information for clothing) and uses text generation AI (e.g., Transformer) to automatically generate category-specific descriptions. The AI output values are reflected in different listing form structures for each category on the user interface (e.g., dimension input fields for furniture, specification input fields for electrical appliances, brand and size selection fields for clothing). In subsequent processing, category-specific listing data is used as input for the flea market API and price estimation AI, and linked to category-specific recommendation engines. As a technical effect, the listing unit automates selection of optimized listing algorithms for each category, thereby improving comprehensiveness and accuracy of information and reducing user burden, which was difficult with conventional uniform listing UIs. Application fields include not only listing of reused items, but also real estate property posting, job information registration, product catalog generation, and any system requiring category-specific information input.

The listing unit is configured to estimate the user's emotions and adjust the length of the listing based on the estimated emotions of the user. For example, if the user is feeling stressed, the listing unit shortens the listing and displays only important information. If the user is relaxed, the listing unit extends the listing and displays detailed information. Furthermore, if the user is in a hurry, the listing unit sets the length of the listing to the shortest possible and enables rapid listing. By adjusting the length of the listing according to the user's emotions, the burden on the user can be reduced. Emotion estimation may be implemented using an emotion engine or generative AI, for example. The generative AI may be a text generation AI (e.g., LLM) or a multimodal generative AI, but is not limited thereto. Some or all of the above-described processing in the listing unit may be performed using AI or without using AI. For example, the listing unit may input the user's facial expression data to the generative AI and have the AI perform emotion estimation. Specifically, the listing unit may input the user's facial expression image (RGB image tensor, 224×224×3), audio data (WAV format, 16 kHz, 1 ch), and input text (UTF-8 string, e.g., “I am busy today”) to the emotion estimation AI module. The emotion estimation AI module extracts image and audio features using CNN and RNN, and text features using BERT, and the fully connected layer outputs emotion labels (e.g., stress, relaxation, urgency) and emotion scores (e.g., stress 0.8). The listing unit inputs the emotion score to the listing length control AI, which, if the stress score is high, limits the maximum number of characters in the listing description (e.g., within 50 characters), minimizes input items, and enables one-click listing mode. In a relaxed state, the maximum number of characters in the description is expanded (e.g., at least 500 characters), additional items (e.g., accessories, purchase date, usage history, condition description) are added, and the photo count restriction is relaxed. In a hurry, past listing history or templates are automatically applied to enable listing completion in as few as two steps. AI output examples include shortened listing: “Product name: book, description: used, 1 photo”; detailed listing: “Product name: refrigerator, description: 300 L capacity, purchased in 2022, good working condition, complete accessories, warranty included, 6 photos”. The output values of the listing length control AI are reflected in the description input field length restriction, photo upload count, and presence of required items on the user interface. In subsequent processing, shortened listings are used for immediate listing or batch listing mode, and detailed listings are used for linking detailed information to the flea market API and as input for automatic price estimation AI. As a technical effect, the listing unit realizes listing length control according to the user's psychological state in a high-dimensional feature space, thereby minimizing user burden and improving the quality of listing information, which was difficult with conventional uniform listing forms. Application fields include not only listing of reused items, but also job posting, event announcement creation, product review submission, and any system requiring information length control according to user state.

The listing unit is configured to determine the priority of the listing based on the submission timing of the item when listing. For example, the listing unit may preferentially list items with imminent deadlines. Items with distant deadlines may be postponed and listed later. Furthermore, the listing unit may dynamically adjust the priority of the listing based on the submission timing. By determining the priority of the listing based on the submission timing of the item, the burden on the user can be reduced. Some or all of the above-described processing in the listing unit may be performed using AI or without using AI. For example, the listing unit may input item submission timing data to the generative AI and have the AI determine the priority of the listing. Specifically, the listing unit may input submission deadline data for each item (date in ISO8601 format, e.g., {“item”:“refrigerator”,“deadline”:“2024-06-28”}) to the listing priority control AI module. The listing priority control AI module sorts all item submission deadlines in chronological order, assigns priority scores (1.0 to 0.0) in order of proximity, and incorporates items with higher priority into the listing flow first. AI output examples include {“item”:“refrigerator”,“priority”:0.95,“deadline”:“2024-06-25”}, {“item”:“bookshelf”,“priority”:0.60,“deadline”:“2024-06-28”}. The AI output values are passed to a module that displays items in order of priority on the user interface, allowing the user to plan listings without missing deadlines. In subsequent processing, high-priority items are used to increase listing notification frequency, and low-priority items are postponed, among other branching processes. As a technical effect, the listing unit automates priority control based on submission timing in a high-dimensional feature space, thereby achieving deadline compliance and listing plan optimization, which was difficult with conventional manual management. Application fields include not only listing of reused items, but also project deadline management, event announcement posting, assignment submission management in education, and any system requiring deadline-based priority control.

The listing unit can adjust the order of listings at the time of listing based on the relevance of items. For example, the listing unit prioritizes the listing of highly relevant items. Additionally, the listing unit may postpone the listing of items with low relevance. Furthermore, the listing unit can dynamically adjust the order of listings based on item relevance. By adjusting the order of listings according to item relevance, the burden on the user can be reduced. Some or all of the above-described processes in the listing unit may be performed using AI or without using AI. For example, the listing unit can input item relevance data into a generation AI and have the generation AI execute the adjustment of the listing order. Specifically, the listing unit inputs relevance data between items (graph structure, e.g., {“itemA”:“dining table”,“itemB”:“chair”,“relation”:0.9}) into a listing order optimization AI module. The listing order optimization AI module uses graph neural networks or Transformer-based models to analyze dependencies and relevance scores between items. Items with high relevance are placed consecutively in the listing flow, while items with low relevance are postponed. Example AI outputs include {“item”:“dining table”,“order”: 1}, {“item”:“chair”,“order”:2}, {“item”:“bookshelf”,“order”:3}, etc. The AI output values are passed to a module that rearranges items in the user interface according to relevance order, allowing the user to grasp an efficient listing order. In subsequent processing, highly relevant items are used for set sale proposals or simultaneous listing notifications, while items with low relevance are used for split listings into separate categories. As a technical effect, the listing unit automates order optimization based on item relevance in a high-dimensional feature space, achieving improved listing efficiency and higher closing rates, which were difficult with conventional manual sorting. Application fields include not only reuse item listings but also product catalog generation, event guide creation, job information posting, and other systems requiring order control based on information relevance.

The quotation acquisition unit can estimate the user's emotions and adjust the method of obtaining quotations based on the estimated emotions of the user. For example, if the user is feeling stressed, the quotation acquisition unit provides a simplified quotation acquisition method. If the user is relaxed, the quotation acquisition unit can provide a detailed quotation acquisition method. Furthermore, if the user is in a hurry, the quotation acquisition unit can provide a method for quickly obtaining quotations. By adjusting the quotation acquisition method according to the user's emotions, the burden on the user can be reduced. Emotion estimation is realized using, for example, an emotion engine or a generation AI with emotion estimation functionality. The generation AI may be a text generation AI (e.g., LLM) or a multimodal generation AI, but is not limited to these examples. Some or all of the above-described processes in the quotation acquisition unit may be performed using AI or without using AI. For example, the quotation acquisition unit can input the user's facial expression data into a generation AI and have the generation AI estimate the emotions. Specifically, the quotation acquisition unit inputs the user's facial image (RGB image tensor, 224×224×3), voice data (WAV format, 16 kHz, 1 ch), and input text (UTF-8 string, e.g., “I'm busy today”) into an emotion estimation AI module. The emotion estimation AI module uses CNN to extract facial features from the image, RNN or Transformer encoder to extract acoustic features (e.g., mel spectrogram, pitch, energy) from the voice waveform, and a language model such as BERT to extract text features. These features are integrated by a multilayer perceptron, and emotion labels (e.g., stress, relaxation, urgency) and emotion scores (real values from 0.0 to 1.0, e.g., stress 0.85) are output. The quotation acquisition unit inputs the output values of the emotion estimation AI into a quotation acquisition control AI, which, if the stress score is high, limits the input items to the minimum (e.g., only main items of the luggage list) and generates a simple UI that allows quotation requests to be completed with one click. In a relaxed state, a detailed UI is presented that allows input of detailed luggage information (e.g., size, weight, packing status, carry-out route for each item) and desired conditions (e.g., work time slot, optional services), and advanced functions such as simultaneous quotation requests to multiple companies and comparison table generation are enabled. In urgent cases, past quotation history or templates are automatically applied, and a flow that completes quotation acquisition in as few as two steps is presented. Example AI outputs include simple quotation: “Number of items: 10, Quotation amount: 12,000 yen”; detailed quotation: “Luggage list: refrigerator (50 kg), washing machine (40 kg), carry-out route: elevator available, desired date: 2024-07-01, Quotation amount: Company A 12,000 yen, Company B 15,000 yen”, etc. The output values of the quotation acquisition control AI are reflected in the number of input form items and the branching of the quotation acquisition flow in the user interface. In subsequent processing, the quotation results are used as input to a company selection AI or reminder notification module, or for immediate notification to the user. As a technical effect, the quotation acquisition unit analyzes the user's psychological state in a high-dimensional feature space in real time, realizing a personalized quotation experience that was difficult with conventional uniform quotation acquisition UIs, thereby improving user experience, reducing input errors and quotation abandonment, and enhancing overall system responsiveness. Application fields include not only moving quotation acquisition but also insurance quotations, renovation quotations, logistics delivery quotations, and other systems requiring quotation acquisition control according to user state.

The quotation acquisition unit can adjust the level of detail of quotations at the time of acquisition based on the importance of the move. For example, for important moving tasks, the quotation acquisition unit obtains detailed quotations and displays fine-grained items. For tasks with low importance, the quotation acquisition unit can obtain simplified quotations and display only the main items. Furthermore, the quotation acquisition unit can dynamically adjust the level of detail of quotations according to the importance of the move. By adjusting the level of detail of quotations based on the importance of the move, the burden on the user can be reduced. Some or all of the above-described processes in the quotation acquisition unit may be performed using AI or without using AI. For example, the quotation acquisition unit can input importance data of moving tasks into a generation AI and have the generation AI execute the adjustment of the level of detail of quotations. Specifically, the quotation acquisition unit inputs importance data of moving tasks assigned by the user or system (numerical score or category label, e.g., {“task”:“large appliance carry-out”,“importance”:0.95}) into a quotation detail control AI module. The quotation detail control AI module dynamically determines the number of items in the quotation form, required detailed information (e.g., carry-out route, floor, elevator availability, number of workers, type of packing materials, work time slot, insurance options), and whether to display a breakdown of the quotation amount according to the input importance score. For tasks with importance of 0.8 or higher, detailed quotation items (e.g., weight, volume, carry-out conditions, need for special work for each item) are required as input, and the output is a detailed breakdown in JSON format (e.g., {“item”:“refrigerator”,“base_price”:5000,“floor_fee”:1000,“insurance”:500}) or a comparison table (detailed quotation list for multiple companies). For tasks with importance less than 0.5, only main items (e.g., number of items, total weight, desired schedule) are input, and the output is only the total amount (e.g., {“total_price”:12000}). The AI output values are reflected in the number of items and level of detail of the quotation form and whether to display the breakdown of the quotation results in the user interface, allowing the user to obtain an optimal quotation experience according to the importance. In subsequent processing, detailed quotation data is used as input to a company selection AI or reminder notification module, and simplified quotation data is used for immediate quotation notification or batch quotation mode. As a technical effect, the quotation acquisition unit realizes control of the level of detail of quotations in a high-dimensional feature space based on the importance of moving tasks, minimizing user burden and improving the quality of quotation information, which were difficult with conventional uniform quotation UIs. In particular, automatic adjustment of detail level by AI reduces troubles due to missing quotations or lack of information for important tasks, and improves quotation accuracy and decision-making efficiency. Application fields include not only moving quotation acquisition but also insurance quotations, renovation quotations, logistics delivery quotations, and other systems requiring control of quotation detail level according to task importance.

The quotation acquisition unit can apply different quotation algorithms according to the category of the move at the time of acquisition. For example, in the case of a family move, the quotation acquisition unit applies an algorithm that considers the luggage of all family members. In the case of a single-person move, the quotation acquisition unit can apply an algorithm optimized for individual luggage. Furthermore, in the case of a corporate move, the quotation acquisition unit can apply an algorithm that integrates the luggage of multiple departments. By applying different quotation algorithms according to the category of the move, the burden on the user can be reduced. Some or all of the above-described processes in the quotation acquisition unit may be performed using AI or without using AI. For example, the quotation acquisition unit can input moving category data into a generation AI and have the generation AI execute the application of quotation algorithms. Specifically, the quotation acquisition unit inputs moving category data selected by the user (e.g., {“category”:“family”}, {“category”:“single”}, {“category”:“corporate”}) into a category-specific quotation AI module. The category-specific quotation AI module internally holds different quotation algorithms for each category (family, single, corporate). For family moves, it integrates multiple users' luggage lists (JSON array, e.g., {“person”:“father”,“items”: [“refrigerator”,“bed”]}), family composition, children's school schedules, and desired dates for all family members, and uses a constraint satisfaction problem (CSP) solver or multi-objective optimization algorithm (e.g., NSGA-II) to generate quotations that maximize everyone's convenience. For single-person moves, it prioritizes the individual's luggage list and desired schedule, and calculates the quotation amount using simple linear regression or decision tree regression models. For corporate moves, it integrates luggage lists for multiple departments, equipment relocation schedules, IT infrastructure switch dates, and work time slots for each department, and uses project management AI (e.g., Gantt chart generation AI or PERT analysis AI) to optimize the whole. The AI output values are presented in the user interface as different quotation structures for each category (e.g., individual quotation list for family, department-specific quotation table for corporate). In subsequent processing, family moves use the results for family coordination notifications, and corporate moves use them as input to inter-department coordination AI. As a technical effect, the quotation acquisition unit automates the selection of optimized quotation algorithms for each category, achieving quotation optimization and reduction of user burden under complex constraint conditions, which were difficult with conventional uniform quotation acquisition. Application fields include not only moving quotation acquisition but also event management quotations, simultaneous multi-project quotations, equipment relocation quotations for educational institutions, and other systems requiring category-specific quotations.

The quotation acquisition unit can estimate the user's emotions and determine the priority of quotations based on the estimated emotions of the user. For example, if the user is feeling stressed, the quotation acquisition unit prioritizes obtaining important quotations. If the user is relaxed, the quotation acquisition unit can prioritize obtaining detailed quotations. Furthermore, if the user is in a hurry, the quotation acquisition unit can prioritize obtaining quotations that can be acquired quickly. By determining the priority of quotations according to the user's emotions, the burden on the user can be reduced. Emotion estimation is realized using, for example, an emotion engine or a generation AI with emotion estimation functionality. The generation AI may be a text generation AI (e.g., LLM) or a multimodal generation AI, but is not limited to these examples. Some or all of the above-described processes in the quotation acquisition unit may be performed using AI or without using AI. For example, the quotation acquisition unit can input the user's facial expression data into a generation AI and have the generation AI estimate the emotions. Specifically, the quotation acquisition unit inputs the user's facial image (RGB image tensor, 224×224×3), voice data (WAV format, 16 kHz, 1 ch), input text (UTF-8 string, e.g., “I'm busy today”), etc., into an emotion estimation AI module. The emotion estimation AI module uses CNN and RNN to extract image and voice features, BERT encoder to extract text features, and a fully connected layer to output emotion labels (e.g., stress, relaxation, urgency) and emotion scores (real values from 0.0 to 1.0, e.g., stress 0.85). The quotation acquisition unit inputs the output values of the emotion estimation AI into a quotation priority control AI, which, if the stress score is high, prioritizes obtaining quotations for high-importance items (e.g., large appliances or high-value items), if relaxed, prioritizes obtaining detailed quotations (e.g., breakdowns of all items and optional services), and if urgent, prioritizes obtaining quotations that can be acquired quickly (e.g., using past templates or companies that support immediate quotations). The AI output values are reflected in the order of quotation acquisition and display order in the user interface, allowing the user to obtain an optimal quotation experience according to their psychological state. In subsequent processing, high-priority quotations are used for immediate notification or increased reminder notification frequency, detailed quotations are used for comparison table generation or input to company selection AI, and rapid quotations are used for immediate decision flow. As a technical effect, the quotation acquisition unit analyzes the user's psychological state in a high-dimensional feature space in real time, realizing a personalized quotation experience and improved decision-making efficiency, which were difficult with conventional uniform quotation acquisition order. Application fields include not only moving quotation acquisition but also insurance quotations, renovation quotations, logistics delivery quotations, and other systems requiring quotation priority control according to user state.

The quotation acquisition unit can determine the priority of quotations at the time of acquisition based on the submission timing of the move. For example, the quotation acquisition unit prioritizes obtaining quotations with imminent submission deadlines. Quotations with distant submission deadlines can be postponed. Furthermore, the quotation acquisition unit can dynamically adjust the priority of quotations based on the submission timing. By determining the priority of quotations according to the submission timing of the move, the burden on the user can be reduced. Some or all of the above-described processes in the quotation acquisition unit may be performed using AI or without using AI. For example, the quotation acquisition unit can input moving submission timing data into a generation AI and have the generation AI execute the determination of quotation priority. Specifically, the quotation acquisition unit inputs submission deadline data for each quotation task (ISO8601 date format, e.g., {“task”:“change of address notification”,“deadline”:“2024-06-28”}) into a quotation priority control AI module. The quotation priority control AI module sorts all quotation tasks by submission deadline in chronological order, assigns priority scores (1.0-0.0) in order of proximity, and incorporates quotations with higher priority into the quotation acquisition flow first. Example AI outputs include {“task”:“change of address notification”,“priority”:0.95,“deadline”:“2024-06-25”}, {“task”:“internet cancellation”,“priority”:0.60,“deadline”:“2024-06-28”}, etc. The AI output values are passed to a module that rearranges quotation tasks in the user interface according to priority order, allowing the user to plan quotations so as not to miss deadlines. In subsequent processing, high-priority quotations are used to increase notification frequency, while low-priority quotations are postponed, etc. As a technical effect, the quotation acquisition unit automates priority control based on submission timing in a high-dimensional feature space, achieving deadline compliance and optimal quotation planning, which were difficult with conventional manual management. Application fields include not only moving quotation acquisition but also project deadline management, event guide posting, educational assignment submission management, and other systems requiring deadline-based priority control.

The quotation acquisition unit can adjust the order of quotations at the time of acquisition based on the relevance of the move. For example, the quotation acquisition unit prioritizes obtaining highly relevant quotations. Quotations with low relevance can be postponed. Furthermore, the quotation acquisition unit can dynamically adjust the order of quotations based on the relevance of the move. By adjusting the order of quotations according to the relevance of the move, the burden on the user can be reduced. Some or all of the above-described processes in the quotation acquisition unit may be performed using AI or without using AI. For example, the quotation acquisition unit can input moving relevance data into a generation AI and have the generation AI execute the adjustment of quotation order. Specifically, the quotation acquisition unit inputs relevance data between quotation tasks (graph structure, e.g., {“taskA”:“packing”,“taskB”:“change of address notification”,“relation”:0.8}) into a quotation order optimization AI module. The quotation order optimization AI module uses graph neural networks or Transformer-based models to analyze dependencies and relevance scores between tasks. Highly relevant quotation tasks are placed consecutively in the quotation acquisition flow, while tasks with low relevance are postponed. Example AI outputs include {“task”:“packing”,“order”: 1}, {“task”:“change of address notification”,“order”:2}, {“task”:“internet cancellation”,“order”:3}, etc. The AI output values are passed to a module that rearranges quotation tasks in the user interface according to relevance order, allowing the user to grasp an efficient quotation acquisition order. In subsequent processing, highly relevant quotation tasks are used for simultaneous notification or grouping, while tasks with low relevance are split into separate schedules. As a technical effect, the quotation acquisition unit automates order optimization based on task relevance in a high-dimensional feature space, achieving improved quotation efficiency and planning accuracy, which were difficult with conventional manual sorting. Application fields include not only moving quotation acquisition but also manufacturing process management quotations, project task quotations, medical procedure order quotations, and other systems requiring order control based on task relevance.

The image recognition unit can estimate the user's emotions and adjust the image recognition method based on the estimated emotions of the user. For example, if the user is feeling stressed, the image recognition unit provides a simplified image recognition method. If the user is relaxed, the image recognition unit can provide a detailed image recognition method. Furthermore, if the user is in a hurry, the image recognition unit can provide a method for rapid image recognition. By adjusting the image recognition method according to the user's emotions, the burden on the user can be reduced. Emotion estimation is realized using, for example, an emotion engine or a generation AI with emotion estimation functionality. The generation AI may be a text generation AI (e.g., LLM) or a multimodal generation AI, but is not limited to these examples. Some or all of the above-described processes in the image recognition unit may be performed using AI or without using AI. For example, the image recognition unit can input the user's facial expression data into a generation AI and have the generation AI estimate the emotions. Specifically, the image recognition unit inputs the user's facial image (RGB image tensor, 224×224×3), voice data (WAV format, 16 kHz, 1 ch), and input text (UTF-8 string, e.g., “I'm busy today”) into an emotion estimation AI module. The emotion estimation AI module uses CNN to extract facial features from the image, RNN or Transformer encoder to extract acoustic features (e.g., mel spectrogram, pitch, energy) from the voice waveform, and a language model such as BERT to extract text features. These features are integrated by a multilayer perceptron, and emotion labels (e.g., stress, relaxation, urgency) and emotion scores (real values from 0.0 to 1.0, e.g., stress 0.85) are output. The image recognition unit inputs the output values of the emotion estimation AI into an image recognition control AI, which, if the stress score is high, simplifies the image recognition pipeline (e.g., performs only object detection and omits detailed segmentation and attribute extraction). In a relaxed state, the image recognition control AI performs multi-stage image analysis (e.g., object detection+segmentation+attribute classification+3D shape estimation) and extracts detailed information such as furniture size, material, color, and installation feasibility. In urgent cases, past recognition results or templates are used to output only compatibility judgments via the shortest path. Example AI inputs include floor plan images (512×512×3), furniture images (224×224×3), and furniture description text (e.g., “120cm wide wooden table”). Example AI outputs include compatibility judgment (binary label: compatible/incompatible), furniture attributes (e.g., width 120 cm, wooden, weight 20 kg), and advice text (e.g., “The width of the carry-in route is insufficient”). The image recognition unit passes these output values to the user interface or subsequent furniture placement simulation module, realizing optimal information presentation according to the user's emotional state. As a technical effect, the image recognition unit analyzes the user's psychological state in a high-dimensional feature space in real time, achieving personalized recognition experiences and optimized processing efficiency, which were difficult with conventional uniform image recognition pipelines. In particular, dynamic pipeline control by AI enables optimal allocation of computational resources, improved response speed, reduced user burden, and suppression of misrecognition. Application fields include not only moving support but also medical image diagnosis, manufacturing line visual inspection, security monitoring, and other systems requiring image recognition control according to user state or situation.

The image recognition unit can adjust the level of detail of image recognition at the time of recognition based on the importance of the furniture. For example, for important furniture, the image recognition unit performs detailed image recognition and recognizes fine features. For furniture with low importance, the image recognition unit can perform simplified image recognition and recognize only the main features. Furthermore, the image recognition unit can dynamically adjust the level of detail of image recognition according to the importance of the furniture. By adjusting the level of detail of image recognition based on the importance of the furniture, the burden on the user can be reduced. Some or all of the above-described processes in the image recognition unit may be performed using AI or without using AI. For example, the image recognition unit can input importance data of furniture into a generation AI and have the generation AI execute the adjustment of the level of detail of image recognition. Specifically, the image recognition unit receives importance data assigned to each piece of furniture (numerical score or category label, e.g., {“item”:“luxury sofa”,“importance”:0.95}) as input. The image recognition unit inputs furniture images (RGB image tensor, 224×224×3 or 512×512×3), furniture description text (UTF-8 string, e.g., “200 cm wide genuine leather sofa”), and optionally numerical data such as furniture dimensions and weight into the AI module. The AI module controls branching of the image recognition pipeline according to the importance score. If the importance is high, the image recognition unit performs multi-stage image analysis, such as object detection and segmentation using CNN or Vision Transformer, contour extraction, material classification (e.g., genuine leather, fabric, wood), color classification, 3D shape estimation (e.g., point cloud generation or mesh reconstruction), damage or stain detection, and accessory presence determination, extracting multiple attributes in detail. The output data is in JSON format, such as an attribute list (e.g., {“item”:“luxury sofa”,“material”:“genuine leather”,“color”:“black”,“width”:200,“depth”:90,“height”:80,“damage”:“none”}) or 3D model data (e.g., glTF format). If the importance is low, the image recognition unit extracts only object detection and main attributes (e.g., category, size, color), omitting detailed segmentation and 3D estimation. Example AI outputs include simple recognition: {“item”:“chair”,“category”:“furniture”,“color”:“white”}; detailed recognition: {“item”:“luxury sofa”,“material”:“genuine leather”,“color”:“black”,“width”:200,“depth”:90,“height”:80,“damage”:“none”}. The AI output values are used in subsequent processing as input to furniture placement simulation, price estimation AI, or automatic generation module for detailed descriptions in the listing unit. As a technical effect, the image recognition unit optimally allocates computational resources and recognition pipelines according to the importance of furniture, achieving both recognition accuracy and processing efficiency, which were difficult with conventional uniform image recognition processing. In particular, for important furniture, it reduces troubles due to misrecognition or lack of information, supporting user decision-making and improving the quality of listing information. Application fields include not only moving support but also reuse item appraisal, insurance appraisal, manufacturing line quality inspection, medical image diagnosis, and other systems requiring control of image recognition detail level according to the importance of the target object.

The image recognition unit can apply different image recognition algorithms according to the category of furniture at the time of recognition. For example, for sofa image recognition, the image recognition unit applies an algorithm that recognizes detailed information such as size and material. For table image recognition, the image recognition unit can apply an algorithm that recognizes shape and material. Furthermore, for bed image recognition, the image recognition unit can apply an algorithm that recognizes size and design. By applying different image recognition algorithms according to the category of furniture, the burden on the user can be reduced. Some or all of the above-described processes in the image recognition unit may be performed using AI or without using AI. For example, the image recognition unit can input furniture category data into a generation AI and have the generation AI execute the application of image recognition algorithms. Specifically, the image recognition unit receives furniture category data selected or automatically estimated by the user (e.g., {“category”:“sofa”}, {“category”:“table”}, {“category”:“bed”}) as input. The image recognition unit inputs furniture images (RGB image tensor, 224×224×3 or 512×512×3), furniture description text (UTF-8 string, e.g., “wooden dining table”), and optionally numerical data such as dimensions and weight into the AI module. The AI module internally holds different image recognition pipelines for each category. For example, for sofas, after object detection using CNN or Vision Transformer, material classification (genuine leather, fabric, synthetic leather), size estimation (width, depth, height), seat shape classification (L-shaped, straight), leg presence determination, and color classification are performed. For tables, tabletop shape (round, rectangular), material (wood, glass, metal), leg structure (four legs, one leg), size estimation, and surface finish classification are performed. For beds, size (single, double, queen), frame material, headboard presence, storage function presence, and design classification (modern, classic, etc.) are extracted. After extracting image features, the AI applies category-specific attribute classifiers or regression models, and generates output data such as attribute lists for each category (e.g., {“category”:“sofa”,“material”:“genuine leather”,“width”:200,“type”:“L-shaped”}) or automatic description generation (e.g., “Genuine leather L-shaped sofa, width 200 cm, with legs”). The AI output values are used in subsequent processing as input to furniture placement simulation, description generation in the listing unit, or price estimation AI. As a technical effect, the image recognition unit automates the selection of optimized algorithms for each furniture category, achieving comprehensive and accurate attribute extraction and reduced user burden, which were difficult with conventional uniform image recognition processing. Application fields include not only moving support but also reuse item appraisal, automatic product catalog generation, manufacturing line part recognition, medical image diagnosis, and other systems requiring category-specific image recognition.

The image recognition unit can estimate the user's emotions and determine the priority of image recognition based on the estimated emotions of the user. For example, if the user is feeling stressed, the image recognition unit prioritizes image recognition of important furniture. If the user is relaxed, the image recognition unit can prioritize detailed image recognition. Furthermore, if the user is in a hurry, the image recognition unit can prioritize selecting furniture for rapid image recognition. By determining the priority of image recognition according to the user's emotions, the burden on the user can be reduced. Emotion estimation is realized using, for example, an emotion engine or a generation AI with emotion estimation functionality. The generation AI may be a text generation AI (e.g., LLM) or a multimodal generation AI, but is not limited to these examples. Some or all of the above-described processes in the image recognition unit may be performed using AI or without using AI. For example, the image recognition unit can input the user's facial expression data into a generation AI and have the generation AI estimate the emotions. Specifically, the image recognition unit inputs the user's facial image (RGB image tensor, 224×224×3), voice data (WAV format, 16 kHz, 1 ch), input text (UTF-8 string, e.g., “I'm busy today”), etc., into an emotion estimation AI module. The emotion estimation AI module uses CNN and RNN to extract image and voice features, BERT to extract text features, and a fully connected layer to output emotion labels (e.g., stress, relaxation, urgency) and emotion scores (e.g., stress 0.8). The image recognition unit inputs the emotion score into an image recognition priority control AI, combines it with a furniture list (JSON array, e.g., {“item”:“refrigerator”,“importance”:0.9}, {“item”:“chair”,“importance”:0.3}), and calculates a priority score. If the stress score is high, the image recognition priority control AI prioritizes recognition of high-importance furniture (e.g., large appliances or high-value furniture); if relaxed, prioritizes detailed recognition (e.g., attribute extraction for all furniture); if urgent, prioritizes selection of furniture with short recognition processing time (e.g., small furniture or furniture for which templates can be applied). The AI output values are reflected in the recognition order and progress display in the user interface, allowing the user to obtain an optimal recognition experience according to their psychological state. In subsequent processing, high-priority furniture is used for immediate recognition result notification or input to placement simulation, detailed recognition is used for description generation in the listing unit or input to price estimation AI, and rapid recognition is used for immediate listing flow. As a technical effect, the image recognition unit analyzes the user's psychological state in a high-dimensional feature space in real time, realizing personalized recognition experiences and improved decision-making efficiency, which were difficult with conventional uniform recognition order. Application fields include not only moving support but also reuse item appraisal, optimization of inspection order in manufacturing lines, medical image diagnosis, and other systems requiring recognition priority control according to user state or situation.

The image recognition unit can determine the priority of image recognition at the time of recognition based on the submission timing of furniture. For example, the image recognition unit prioritizes image recognition of furniture with imminent submission deadlines. Image recognition of furniture with distant submission deadlines can be postponed. Furthermore, the image recognition unit can dynamically adjust the priority of image recognition based on the submission timing. By determining the priority of image recognition according to the submission timing of furniture, the burden on the user can be reduced. Some or all of the above-described processes in the image recognition unit may be performed using AI or without using AI. For example, the image recognition unit can input furniture submission timing data into a generation AI and have the generation AI execute the determination of image recognition priority. Specifically, the image recognition unit inputs submission deadline data for each piece of furniture (ISO8601 date format, e.g., {“item”:“refrigerator”,“deadline”:“2024-06-28”}) into an image recognition priority control AI module. The image recognition priority control AI module sorts all furniture by submission deadline in chronological order, assigns priority scores (1.0-0.0) in order of proximity, and incorporates furniture with higher priority into the image recognition flow first. Example AI outputs include {“item”:“refrigerator”,“priority”:0.95,“deadline”:“2024-06-25”}, {“item”:“bookshelf”,“priority”:0.60,“deadline”:“2024-06-28”}, etc. The AI output values are passed to a module that rearranges furniture in the user interface according to priority order, allowing the user to plan recognition so as not to miss deadlines. In subsequent processing, high-priority furniture is used for immediate recognition result notification or input to placement simulation, while low-priority furniture is postponed, etc. As a technical effect, the image recognition unit automates priority control based on submission timing in a high-dimensional feature space, achieving deadline compliance and optimal recognition planning, which were difficult with conventional manual management. Application fields include not only moving support but also reuse item appraisal, manufacturing process management, event guide posting, educational assignment submission management, and other systems requiring deadline-based priority control.

The image recognition unit can adjust the order of image recognition at the time of recognition based on the relevance of furniture. For example, the image recognition unit prioritizes image recognition of highly relevant furniture. Image recognition of furniture with low relevance can be postponed. Furthermore, the image recognition unit can dynamically adjust the order of image recognition based on the relevance of furniture. By adjusting the order of image recognition according to the relevance of furniture, the burden on the user can be reduced. Some or all of the above-described processes in the image recognition unit may be performed using AI or without using AI. For example, the image recognition unit can input furniture relevance data into a generation AI and have the generation AI execute the adjustment of image recognition order. Specifically, the image recognition unit inputs relevance data between furniture items (graph structure, e.g., {“itemA”:“dining table”,“itemB”:“chair”,“relation”:0.9}) into an image recognition order optimization AI module. The image recognition order optimization AI module uses graph neural networks or Transformer-based models to analyze dependencies and relevance scores between furniture items. Highly relevant furniture items are placed consecutively in the image recognition flow, while items with low relevance are postponed. Example AI outputs include {“item”:“dining table”,“order”: 1}, {“item”:“chair”,“order”:2}, {“item”:“bookshelf”,“order”:3}, etc. The AI output values are passed to a module that rearranges furniture in the user interface according to relevance order, allowing the user to grasp an efficient recognition order. In subsequent processing, highly relevant furniture is used for set placement proposals or simultaneous recognition notifications, while furniture with low relevance is used for split recognition into separate categories. As a technical effect, the image recognition unit automates order optimization based on furniture relevance in a high-dimensional feature space, achieving improved recognition efficiency and decision-making accuracy, which were difficult with conventional manual sorting. Application fields include not only moving support but also product catalog generation, manufacturing process management, event guide creation, medical image diagnosis, and other systems requiring order control based on information relevance.

The system according to the embodiment is not limited to the examples described above, and various modifications are possible, for example, as follows. Specifically, the system can flexibly expand the AI module configuration and data flow of each unit. For example, in the image recognition unit, category-specific image recognition algorithms or multitask learning models can be additionally implemented to support recognition of various categories of items such as home appliances, daily goods, and clothing, in addition to furniture. In the reception unit and generation unit, real-time data from wearable devices or biometric information (e.g., heart rate, skin conductance) can be used as input to improve the accuracy of user state estimation and enhance the degree of personalization of interactions. Furthermore, in the listing unit and quotation acquisition unit, integration with external price estimation APIs and logistics company APIs can be strengthened to realize automatic acquisition and reflection of real-time market prices and available delivery schedules. Regarding AI model architecture, in addition to CNN and Transformer, combining graph neural networks and time-series analysis models (LSTM, Temporal Convolutional Network, etc.) enables advanced judgment and recommendations that consider complex dependencies and time-series patterns. From the perspective of data flow, intermediate outputs between AI modules can be linked via a common database or message queue, and partial inference execution on distributed processing clusters or edge devices can be allowed to improve overall system scalability and responsiveness. As a technical effect, these expansions and modifications enable the system to achieve flexible adaptability and high processing efficiency and accuracy in multimodal, multicategory, and multiuser environments, compared to conventional single-purpose, single-modal processing. Application fields include not only moving support but also reuse item distribution, logistics optimization, medical and nursing care support, progress management in the education field, process management in manufacturing, and other systems requiring collaboration among multiple categories, users, and devices.

The reception unit can analyze the user's past moving history and select an optimal input method. For example, the reception unit preferentially proposes input methods (such as voice or text) that the user has used in the past. Additionally, the reception unit can automatically complete input items by referring to information previously entered by the user. Furthermore, the reception unit can extract specific patterns from the user's past moving history and propose optimal input methods. By analyzing the user's past moving history, the optimal input method can be provided. Some or all of the above-described processes in the reception unit may be performed using AI or without using AI. For example, the reception unit can input the user's past moving data into a generation AI and have the generation AI select the optimal input method.

The reception unit can perform filtering based on the user's current living situation or areas of interest when inputting the new address or desired move-in date. For example, if the user has a pet, the reception unit preferentially displays properties that allow pets. If the user values commuting time, the reception unit can preferentially display properties with short commuting times. Furthermore, if the user desires a specific school district, the reception unit can preferentially display properties within that school district. By performing filtering based on the user's living situation or areas of interest, more appropriate information can be provided. Some or all of the above-described processes in the reception unit may be performed using AI or without using AI. For example, the reception unit can input the user's living situation data into a generation AI and have the generation AI execute filtering.

The reception unit can estimate the user's emotions and determine the priority of information to be input based on the estimated emotions of the user. For example, if the user is feeling stressed, the reception unit prioritizes input of important information and postpones detailed information. If the user is relaxed, the reception unit can prioritize input of detailed information. Furthermore, if the user is in a hurry, the reception unit can prioritize input of minimal information. By determining the priority of information to be input according to the user's emotions, the burden on the user can be reduced. Emotion estimation is realized using, for example, an emotion engine or a generation AI with emotion estimation functionality. The generation AI may be a text generation AI (e.g., LLM) or a multimodal generation AI, but is not limited to these examples. Some or all of the above-described processes in the reception unit may be performed using AI or without using AI. For example, the reception unit can input the user's facial expression data into a generation AI and have the generation AI estimate the emotions.

The generation unit can estimate the user's emotions and adjust the schedule generation method based on the estimated emotions of the user. For example, if the user is feeling stressed, the generation unit simplifies the schedule and displays only important tasks. If the user is relaxed, the generation unit can generate a detailed schedule and display fine-grained tasks. Furthermore, if the user is in a hurry, the generation unit can generate a schedule that can be completed in the shortest time. By adjusting the schedule generation method according to the user's emotions, the burden on the user can be reduced. Emotion estimation is realized using, for example, an emotion engine or a generation AI with emotion estimation functionality. The generation AI may be a text generation AI (e.g., LLM) or a multimodal generation AI, but is not limited to these examples. Some or all of the above-described processes in the generation unit may be performed using AI or without using AI. For example, the generation unit can input the user's facial expression data into a generation AI and have the generation AI estimate the emotions. Specifically, the generation unit inputs the user's facial image (RGB image tensor, 224×224×3), voice data (WAV format, 16 kHz, 1 ch), and input text (UTF-8 string, e.g., “I'm busy today”) into an emotion estimation AI module. The emotion estimation AI module uses CNN to extract facial features from the image, RNN or Transformer encoder to extract acoustic features (e.g., mel spectrogram, pitch, energy) from the voice waveform, and a language model such as BERT to extract text features. These features are integrated by a multilayer perceptron, and emotion labels (e.g., stress, relaxation, urgency) and emotion scores (real values from 0.0 to 1.0, e.g., stress 0.85) are output. The generation unit inputs the output values of the emotion estimation AI into a schedule generation AI, which uses a Transformer-based large language model to switch schedule generation policies according to the user's emotional state. For example, if the stress score is high, the schedule generation AI extracts only main tasks such as “packing” and “moving procedures” and outputs a simplified schedule in tabular format (CSV or JSON array, e.g., {“task”:“packing”,“date”:“2024-06-25”}). In a relaxed state, subtasks (e.g., packing for each room, mail forwarding procedures, internet cancellation, etc.) are broken down in detail, and attributes such as date, person in charge, and required time are added to generate a detailed schedule. In urgent cases, the required time for all tasks is estimated, the shortest completion order is determined using shortest path search algorithms (e.g., Dijkstra's algorithm or A* search), and only high-priority tasks are extracted and output. The AI output values are presented in the user interface in tabular or Gantt chart format, allowing the user to immediately check a schedule optimized for their emotional state. In subsequent processing, the schedule generation results are also used as input to a reminder notification module or company quotation acquisition AI. As a technical effect, the generation unit analyzes the user's psychological state in a high-dimensional feature space in real time, realizing personalized plan presentation, which was difficult with conventional uniform schedule generation, thereby improving user experience, reducing input errors and planning delays, and enhancing overall system responsiveness. Application fields include not only moving support but also project management, medical scheduling, learning plan generation in the education field, and other systems requiring dynamic schedule generation according to user state.

The generation unit can adjust the level of detail of the schedule at the time of schedule generation based on the importance of the move. For example, for important moving tasks, the generation unit sets a detailed schedule and displays fine-grained tasks. For tasks with low importance, the generation unit can set a simplified schedule and display only the main tasks. Furthermore, the generation unit can dynamically adjust the level of detail of the schedule according to the importance of the move. By adjusting the level of detail of the schedule based on the importance of the move, the burden on the user can be reduced. Some or all of the above-described processes in the generation unit may be performed using AI or without using AI. For example, the generation unit can input importance data of moving tasks into a generation AI and have the generation AI execute the adjustment of the level of detail of the schedule. Specifically, the generation unit inputs importance data of moving tasks assigned by the user or system (numerical score or category label, e.g., {“task”:“packing”,“importance”:0.95}) into a schedule generation AI. The schedule generation AI uses a Transformer-based large language model to control the level of detail of the schedule according to the importance score of each task. For tasks with importance of 0.8 or higher, detailed information such as subtask breakdown (e.g., “packing the refrigerator,” “draining the washing machine”), assignment of person in charge, required time estimation, and generation of necessary materials list are added and output in CSV or JSON array format. For tasks with importance less than 0.5, only the main task name and scheduled date are displayed in a simplified manner, and detailed information is omitted. Example AI outputs include detailed schedule: {“task”:“packing”,“subtasks”: [“packing refrigerator”,“draining washing machine”],“date”:“2024-06-25”,“person”:“self”,“duration”: 120}; simplified schedule: {“task”:“mail forwarding procedure”,“date”:“2024-06-28”}. The output values of the schedule generation AI are passed to a module that automatically switches between detailed and simplified display in the user interface, allowing the user to select the granularity of the schedule according to their needs. In subsequent processing, detailed schedules are used as input to reminder notifications or progress management AI, and simplified schedules are used for overview display of the overall plan. As a technical effect, the generation unit realizes control of schedule detail level in a high-dimensional feature space based on task importance, minimizing user burden and improving planning accuracy, which were difficult with conventional uniform schedule presentation. Application fields include not only moving support but also project management, manufacturing process planning, medical surgery scheduling, and other systems requiring dynamic schedule generation according to task importance.

The listing unit can estimate the user's emotions and adjust the method of expressing the listing based on the estimated emotions of the user. For example, if the user is feeling stressed, the listing unit provides a simple expression method and simplifies the listing procedure. If the user is relaxed, the listing unit can provide a detailed expression method and propose a customizable listing method. Furthermore, if the user is in a hurry, the listing unit can complete the listing with minimal information for rapid listing. By adjusting the method of expressing the listing according to the user's emotions, the burden on the user can be reduced. Emotion estimation is realized using, for example, an emotion engine or a generation AI with emotion estimation functionality. The generation AI may be a text generation AI (e.g., LLM) or a multimodal generation AI, but is not limited to these examples. Some or all of the above-described processes in the listing unit may be performed using AI or without using AI. For example, the listing unit can input the user's facial expression data into a generation AI and have the generation AI estimate the emotions. Specifically, the listing unit inputs the user's facial image (RGB image tensor, 224×224×3), voice data (WAV format, 16 kHz, 1 ch), and input text (UTF-8 string, e.g., “I'm busy today”) into an emotion estimation AI module. The emotion estimation AI module uses CNN to extract facial features from the image, RNN or Transformer encoder to extract acoustic features (e.g., mel spectrogram, pitch, energy) from the voice waveform, and a language model such as BERT to extract text features. These features are integrated by a multilayer perceptron, and emotion labels (e.g., stress, relaxation, urgency) and emotion scores (real values from 0.0 to 1.0, e.g., stress 0.85) are output. The listing unit inputs the output values of the emotion estimation AI into a listing expression control AI, which, if the stress score is high, templates the listing description, limits input items to the minimum (e.g., only product name, price, and category), and generates a UI that allows listing to be completed with one click. In a relaxed state, advanced editing functions such as detailed description generation (e.g., product features, usage history, accessories, purchase date), custom tag assignment, increased number of photos, and layout selection are enabled. In urgent cases, past listing history or templates for similar products are automatically applied, and a flow that completes listing in as few as two steps is presented. Example AI outputs include simple listing: “Product name: chair, Price: 2,000 yen, Category: furniture”; detailed listing: “Product name: chair, Price: 2,000 yen, Category: furniture, Description: wooden, width 50 cm, purchased 2 years ago, no noticeable scratches, 5 photos”. The output values of the listing expression control AI are reflected in the number of items in the listing form, length of description, and photo count limit in the user interface. In subsequent processing, the listing content is sent to the flea market API and also used as input to listing completion notification or automatic price adjustment AI. As a technical effect, the listing unit analyzes the user's psychological state in a high-dimensional feature space in real time, realizing a personalized listing experience that was difficult with conventional uniform listing UIs, thereby improving user experience, reducing input errors and listing abandonment, and enhancing overall system responsiveness. Application fields include not only reuse item listing but also job information posting, event guide creation, product review posting, and other systems requiring expression control according to user state.

The listing unit is capable of adjusting the level of detail of listings based on the importance of the items at the time of listing. For example, for important items, detailed descriptions can be added and more photographs can be posted. Conversely, for items of lower importance, the listing unit can add simplified descriptions and limit the number of photographs. Furthermore, the listing unit can dynamically adjust the level of detail of the listing according to the importance of the item. By adjusting the level of detail of the listing based on the importance of the item, the burden on the user can be reduced. Some or all of the above-described processes in the listing unit may be performed using AI, or may be performed without AI. For example, the listing unit can input item importance data into a generative AI and have the generative AI execute the adjustment of the listing detail level. Specifically, the listing unit inputs item importance data (numerical score or category label, e.g., {“item”:“luxury watch”,“importance”:0.95}) assigned by the user or system into a listing detail control AI module. The listing detail control AI module dynamically determines, according to the input importance score, the length of the listing description, the number of photographs to be posted, and the presence or absence of additional information items (e.g., accessories, purchase date, warranty certificate, usage history, etc.). For example, for items with an importance score of 0.8 or higher, the module automatically generates a description of 500 characters or more, at least five photographs, and mandatory items such as detailed specifications and accessory lists, outputting data in JSON format (e.g., {“item”:“luxury watch”,“description”:“Purchased in 2022, complete accessories, no noticeable scratches”}) and generating an image file list. For items with an importance score below 0.5, only a simple description (within 100 characters) including item name, price, and category is recommended, with only one photograph, and the input fields in the listing form are minimized. The AI output values are reflected in the user interface as the number of fields in the listing form, the length of the description, and the limit on the number of photographs, allowing the user to experience an optimal listing process according to the importance of the item. In subsequent processing, detailed listing data is used as input for the flea market API or price estimation AI, while simplified listing data is used for immediate listing or batch listing modes. As a technical effect, the listing unit realizes control of listing detail level in a high-dimensional feature space based on item importance, minimizing user burden and improving the quality of listing information, which was difficult with conventional uniform listing UIs. In particular, automatic adjustment of detail level by AI reduces troubles caused by misdescription or lack of information for important items, and improves listing efficiency and contract rate. Applicable fields include not only reuse item listings, but also job postings, event announcements, product review submissions, and any system requiring expression control according to the importance of information.

The quotation acquisition unit is capable of estimating the user's emotions and adjusting the method of obtaining quotations based on the estimated emotions of the user. For example, if the user is feeling stressed, a simplified quotation acquisition method is provided. If the user is relaxed, the quotation acquisition unit can provide a more detailed quotation acquisition method. Furthermore, if the user is in a hurry, the quotation acquisition unit can provide a method for quickly obtaining quotations. By adjusting the quotation acquisition method according to the user's emotions, the burden on the user can be reduced. Emotion estimation is realized, for example, by using an emotion engine or generative AI with emotion estimation functionality. The generative AI may be a text generation AI (such as an LLM) or a multimodal generative AI, but is not limited to these examples. Some or all of the above-described processes in the quotation acquisition unit may be performed using AI, or may be performed without AI. For example, the quotation acquisition unit can input the user's facial expression data into a generative AI and have the generative AI estimate the emotions. Specifically, the quotation acquisition unit inputs the user's facial expression image (RGB image tensor, 224×224×3), audio data (WAV format, 16 kHz, 1 ch), and input text (UTF-8 string, e.g., “I'm busy today”) into an emotion estimation AI module. The emotion estimation AI module extracts facial features from the expression image using a CNN, extracts acoustic features (e.g., mel spectrogram, pitch, energy) from the audio waveform using an RNN or Transformer encoder, and extracts text features using a language model such as BERT. These features are integrated using a multilayer perceptron, and emotion labels (e.g., stress, relaxation, urgency) and emotion scores (real values from 0.0 to 1.0, e.g., stress 0.85) are output. The quotation acquisition unit inputs the output values of the emotion estimation AI into a quotation acquisition control AI, which, if the stress score is high, limits the input fields to a minimum (e.g., only the main items of the luggage list) and generates a simplified UI that allows quotation requests to be completed with one click. In a relaxed state, a detailed UI is presented that allows input of detailed luggage information (e.g., size, weight, packing status, carry-out route for each item) and desired conditions (e.g., work time slot, optional services), and advanced functions such as simultaneous quotation requests to multiple companies and generation of comparison tables are enabled. In urgent cases, past quotation history or templates are automatically applied, and a flow is presented that allows quotation acquisition to be completed in as few as two steps. Examples of AI output include: simplified quotation: “Number of items: 10, quotation amount: 12,000 yen”; detailed quotation: “Luggage list: refrigerator (50 kg), washing machine (40 kg), carry-out route: elevator available, desired date: 2024-07-01, quotation amount: Company A 12,000 yen, Company B 15,000 yen”, etc. The output values of the quotation acquisition control AI are reflected in the user interface as the number of fields in the input form and the branching of the quotation acquisition flow. In subsequent processing, the quotation results are used as input for a company selection AI or reminder notification module, or for immediate notification to the user. As a technical effect, the quotation acquisition unit analyzes the user's psychological state in a high-dimensional feature space in real time, realizing a personalized quotation experience that was difficult with conventional uniform quotation acquisition UIs, thereby improving user experience, reducing input errors and quotation abandonment, and enhancing the overall system responsiveness. Applicable fields include not only moving quotations, but also insurance quotations, renovation quotations, logistics delivery quotations, and any system requiring quotation acquisition control according to user state.

The quotation acquisition unit is capable of adjusting the level of detail of quotations based on the importance of the moving task at the time of quotation acquisition. For example, for important moving tasks, detailed quotations can be obtained and detailed items can be displayed. Conversely, for tasks of lower importance, the quotation acquisition unit can obtain simplified quotations and display only the main items. Furthermore, the quotation acquisition unit can dynamically adjust the level of detail of the quotation according to the importance of the moving task. By adjusting the level of detail of the quotation based on the importance of the moving task, the burden on the user can be reduced. Some or all of the above-described processes in the quotation acquisition unit may be performed using AI, or may be performed without AI. For example, the quotation acquisition unit can input moving task importance data into a generative AI and have the generative AI execute the adjustment of the quotation detail level. Specifically, the quotation acquisition unit inputs moving task importance data (numerical score or category label, e.g., {“task”:“large appliance removal”,“importance”:0.95}) assigned by the user or system into a quotation detail control AI module. The quotation detail control AI module dynamically determines, according to the input importance score, the number of fields in the quotation form, the required detailed information (e.g., carry-out route, number of floors, elevator availability, number of workers, type of packing materials, work time slot, insurance options, etc.), and the presence or absence of breakdown display of the quotation amount. For example, for tasks with an importance score of 0.8 or higher, detailed quotation items (e.g., weight, volume, carry-out conditions, need for special work for each item) are required as input, and the quotation output is generated in JSON format with detailed breakdowns (e.g., {“item”:“refrigerator”,“base_price”:5000,“floor_fee”:1000,“insurance”:500}) or as comparison tables (lists of detailed quotations from multiple companies). For tasks with an importance score below 0.5, only main items (e.g., number of items, total weight, desired schedule) are input, and the quotation output is limited to the total amount only (e.g., {“total_price”:12000}). The AI output values are reflected in the user interface as the number of fields in the quotation form, the level of detail, and the presence or absence of breakdown display in the quotation results, allowing the user to experience an optimal quotation process according to the importance of the task. In subsequent processing, detailed quotation data is used as input for a company selection AI or reminder notification module, while simplified quotation data is used for immediate quotation notification or batch quotation mode. As a technical effect, the quotation acquisition unit realizes control of quotation detail level in a high-dimensional feature space based on the importance of moving tasks, minimizing user burden and improving the quality of quotation information, which was difficult with conventional uniform quotation UIs. In particular, automatic adjustment of detail level by AI reduces troubles caused by missing quotations or lack of information for important tasks, and improves quotation accuracy and decision-making efficiency. Applicable fields include not only moving quotations, but also insurance quotations, renovation quotations, logistics delivery quotations, and any system requiring control of quotation detail level according to task importance.

The image recognition unit is capable of estimating the user's emotions and adjusting the method of image recognition based on the estimated emotions of the user. For example, if the user is feeling stressed, a simplified image recognition method is provided. If the user is relaxed, the image recognition unit can provide a more detailed image recognition method. Furthermore, if the user is in a hurry, the image recognition unit can provide a method for quickly performing image recognition. By adjusting the image recognition method according to the user's emotions, the burden on the user can be reduced. Emotion estimation is realized, for example, by using an emotion engine or generative AI with emotion estimation functionality. The generative AI may be a text generation AI (such as an LLM) or a multimodal generative AI, but is not limited to these examples. Some or all of the above-described processes in the image recognition unit may be performed using AI, or may be performed without AI. For example, the image recognition unit can input the user's facial expression data into a generative AI and have the generative AI estimate the emotions. Specifically, the image recognition unit inputs the user's facial expression image (RGB image tensor, 224×224×3), audio data (WAV format, 16 kHz, 1 ch), and input text (UTF-8 string, e.g., “I'm busy today”) into an emotion estimation AI module. The emotion estimation AI module extracts facial features from the expression image using a CNN, extracts acoustic features (e.g., mel spectrogram, pitch, energy) from the audio waveform using an RNN or Transformer encoder, and extracts text features using a language model such as BERT. These features are integrated using a multilayer perceptron, and emotion labels (e.g., stress, relaxation, urgency) and emotion scores (real values from 0.0 to 1.0, e.g., stress 0.85) are output. The image recognition unit inputs the output values of the emotion estimation AI into an image recognition control AI, which, if the stress score is high, simplifies the image recognition pipeline. For example, only object detection is performed, and detailed segmentation or attribute extraction is omitted. In a relaxed state, the image recognition control AI executes multi-stage image analysis (e.g., object detection+segmentation+attribute classification+3D shape estimation), extracting detailed information such as furniture size, material, color, and installation feasibility. In urgent cases, past recognition results or templates are utilized, and only compatibility judgment is output via the shortest route. Examples of AI input include floor plan images (512×512×3), furniture images (224×224×3), and furniture description text (e.g., “wooden table, 120 cm wide”). Examples of AI output include compatibility judgment (binary label: compatible/incompatible), furniture attributes (e.g., width 120 cm, wooden, weight 20 kg), and advice text (e.g., “The width of the carry-in route is insufficient”). The image recognition unit passes these output values to the user interface and subsequent furniture arrangement simulation modules, realizing optimal information presentation according to the user's emotional state. As a technical effect, the image recognition unit analyzes the user's psychological state in a high-dimensional feature space in real time, realizing a personalized recognition experience and optimization of processing efficiency that was difficult with conventional uniform image recognition pipelines. In particular, dynamic pipeline control by AI enables optimal allocation of computational resources, improved response speed, reduced user burden, and suppression of misrecognition. Applicable fields include not only moving support, but also medical image diagnosis, appearance inspection in manufacturing lines, security monitoring, and any system requiring image recognition control according to user state or situation.

The following is a brief explanation of the processing flow of Example of the Embodiment. Specifically, the present system integrates modules including a reception unit, a generation unit, a listing unit, a quotation acquisition unit, and an image recognition unit, and processes user input through listing, quotation acquisition, and image recognition in a seamless manner. The reception unit analyzes the user's past history, current living situation, and emotional state in a multidimensional feature space, realizing optimal input methods, information filtering, and input priority control. The generation unit dynamically controls schedule generation policies and detail levels using a Transformer-based large language model or time-series analysis model, based on information received from the reception unit and user emotion/task importance data. The listing unit receives user emotion and item importance data as input, and combines description generation AI and image analysis AI to automatically adjust the number of fields in the listing form, description length, and number of photographs, providing a personalized listing experience. The quotation acquisition unit receives user emotion, task importance, and category data as input, and quotation acquisition control AI and detail control AI optimize the number of fields in the quotation form and output content, automating quotation acquisition from multiple companies and generation of comparison tables. The image recognition unit receives user emotion, furniture importance, category, submission timing, and relevance data as input, and dynamically controls the image recognition pipeline by combining CNNs, Vision Transformers, and graph neural networks, executing object detection, attribute extraction, 3D shape estimation, and compatibility judgment. The output values of each AI module are linked to the user interface and subsequent modules such as recommendation engines, reminder notifications, price estimation, and furniture arrangement simulation, realizing personalized information presentation and decision support according to user state, task importance, category, submission timing, and relevance. As a technical effect, the present system realizes high-precision, high-efficiency information input, scheduling, listing, quotation acquisition, and image recognition, which were difficult with conventional uniform UIs and manual processing, thereby minimizing user burden, reducing input errors, planning delays, and misrecognition, and improving overall system responsiveness, contract rate, and decision-making efficiency. Applicable fields include not only moving support, but also reuse item distribution, project management, and systems in medical, educational, and manufacturing fields requiring progress management, information input, recommendation, and recognition.

Step 1: The reception unit receives input of the user's new address and desired move-in date. The user's new address may include, for example, postal code, building name, and room number. The desired move-in date may be input in date format or time slot, for example. Step 2: The generation unit generates a schedule based on the information received by the reception unit. Schedule generation is performed, for example, based on task priority and time allocation. Step 3: The listing unit allows the user to take photographs of items to be sold, upload them to a generation algorithm to set an appropriate price, and list them in a flea market. The appropriate price is calculated, for example, based on market price and the balance of supply and demand. Step 4: The quotation acquisition unit estimates the amount of moving luggage when the user inputs the quantity and obtains quotations from multiple moving companies. The estimation of the amount of luggage is performed, for example, based on the type, weight, and volume of items. Step 5: The image recognition unit determines, using image recognition technology, whether furniture is compatible when the user uploads a floor plan of the new residence and photographs of furniture. The image recognition technology is realized, for example, by object detection or image classification techniques. Specifically, in Step 1, the reception unit receives user input data (e.g., postal code “107-0062”, building name “Aoyama Tower”, room number “1203”, desired move-in date “2024-07-01”, etc. in JSON structure), and presents input candidates or property candidates using input completion AI or filtering AI. In Step 2, the generation unit inputs the information received from the reception unit into a Transformer-based schedule generation AI, and generates a schedule (e.g., {“task”:“packing”,“date”:“2024-06-25”}) considering task priority and time allocation. In Step 3, the listing unit inputs user-taken item images (224×224×3) and description text into image recognition AI and description generation AI, automatically generates an appropriate price (e.g., market price 12,000 yen) and listing description, and sends the listing data to the flea market API. In Step 4, the quotation acquisition unit inputs the user's luggage list (e.g., {“item”:“refrigerator”,“weight”:50,“volume”:0.5}) into the quotation acquisition AI, and obtains a list of quotation amounts from multiple companies (e.g., {“company”:“Company A”,“price”: 12,000}). In Step 5, the image recognition unit inputs the floor plan image (512×512×3) and furniture image (224×224×3) into a CNN or Vision Transformer, determines furniture size, shape, and installation feasibility, and outputs compatibility judgment (e.g., “compatible” or “incompatible”) and advice text (e.g., “The width of the carry-in route is insufficient”). The output values of each step are linked to the user interface and subsequent recommendation, notification, and simulation modules, realizing personalized information presentation and decision support according to user state, input content, item attributes, company information, and image information. As a technical effect, the present system realizes high-precision, high-efficiency information input, scheduling, listing, quotation acquisition, and image recognition, which were difficult with conventional manual and uniform processing, thereby minimizing user burden, reducing input errors, planning delays, and misrecognition, and improving overall system responsiveness, contract rate, and decision-making efficiency. Applicable fields include not only moving support, but also reuse item distribution, project management, and systems in medical, educational, and manufacturing fields requiring progress management, information input, recommendation, and recognition.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the aforementioned reception unit, generation unit, listing unit, quotation acquisition unit, and image recognition unit is implemented, for example, by at least one of a smart device 14 and a data processing apparatus 12. For example, the reception unit is implemented by a control unit 46A of the smart device 14 and receives input of the user's new address or desired move-in date. The generation unit is implemented, for example, by a specific processing unit 290 of the data processing apparatus 12 and generates a schedule based on information received by the reception unit. The listing unit is implemented, for example, by the control unit 46A of the smart device 14 and allows the user to take photographs of items to be sold, set an appropriate price by uploading them to a generation AI, and list them in a flea market. The quotation acquisition unit is implemented, for example, by the specific processing unit 290 of the data processing apparatus 12 and estimates the amount of moving luggage when the user inputs the quantity and obtains quotations from multiple moving companies. The image recognition unit is implemented, for example, by the control unit 46A of the smart device 14 and determines, using image recognition technology, whether furniture is compatible when the user uploads a floor plan of the new residence and photographs of furniture. The correspondence between each unit and the apparatus or control unit is not limited to the examples described above and various modifications are possible.

### Second Embodiment

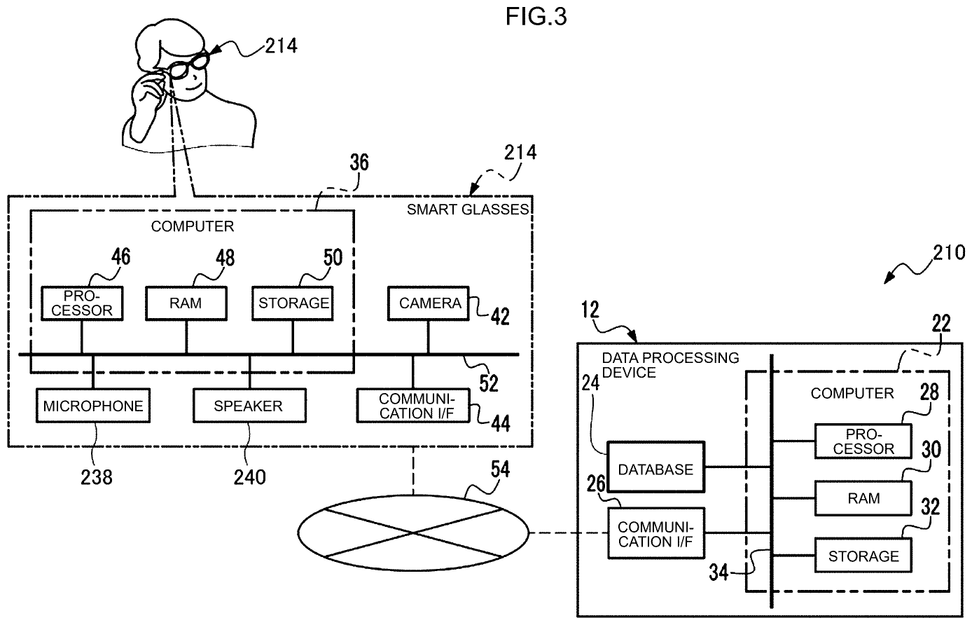

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

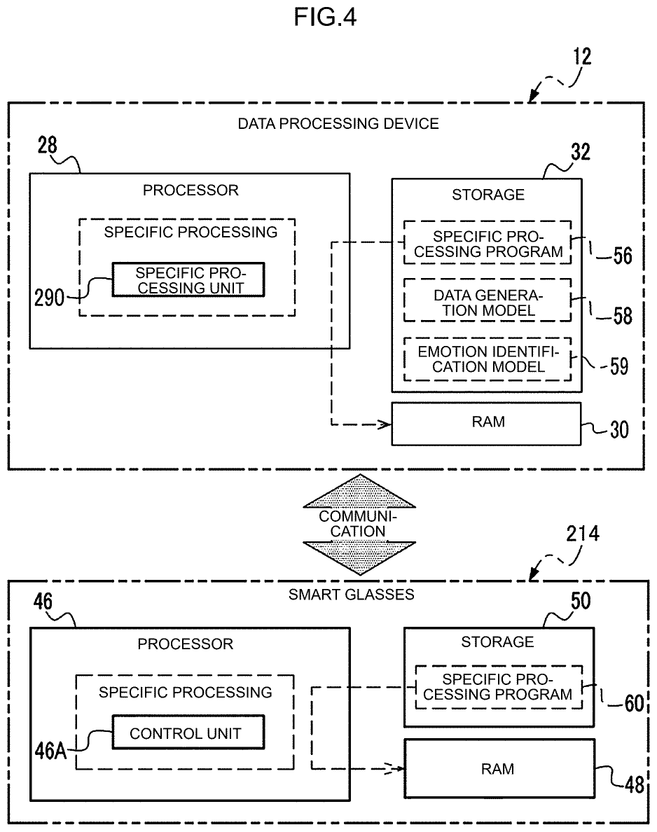

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the aforementioned reception unit, generation unit, listing unit, quotation acquisition unit, and image recognition unit is implemented, for example, by at least one of a smart glasses 214 and a data processing apparatus 12. For example, the reception unit is implemented by a control unit 46A of the smart glasses 214 and receives input of the user's new address or desired move-in date. The generation unit is implemented, for example, by a specific processing unit 290 of the data processing apparatus 12 and generates a schedule based on information received by the reception unit. The listing unit is implemented, for example, by the control unit 46A of the smart glasses 214 and allows the user to take photographs of items to be sold, set an appropriate price by uploading them to a generation AI, and list them in a flea market. The quotation acquisition unit is implemented, for example, by the specific processing unit 290 of the data processing apparatus 12 and estimates the amount of moving luggage when the user inputs the quantity and obtains quotations from multiple moving companies. The image recognition unit is implemented, for example, by the control unit 46A of the smart glasses 214 and determines, using image recognition technology, whether furniture is compatible when the user uploads a floor plan of the new residence and photographs of furniture. The correspondence between each unit and the apparatus or control unit is not limited to the examples described above and various modifications are possible.

### Third Embodiment

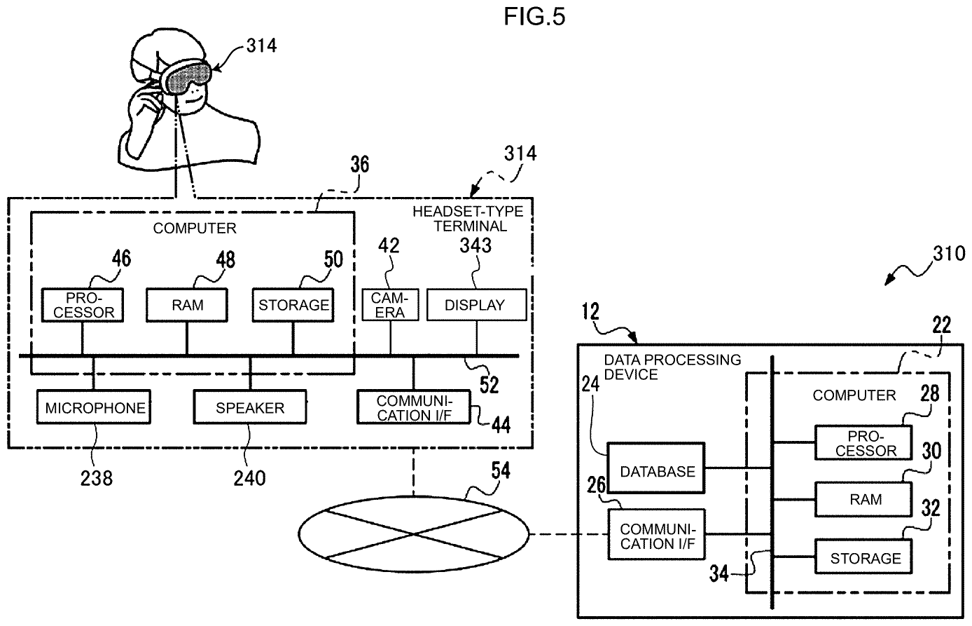

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

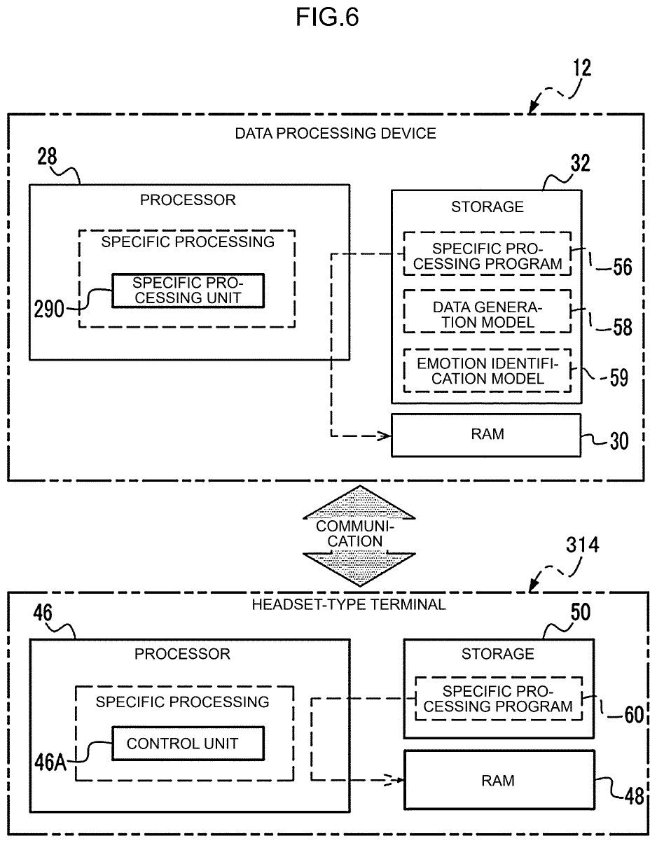

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the aforementioned reception unit, generation unit, listing unit, quotation acquisition unit, and image recognition unit is implemented, for example, by at least one of a headset-type terminal 314 and a data processing apparatus 12. For example, the reception unit is implemented by a control unit 46A of the headset-type terminal 314 and receives input of the user's new address or desired move-in date. The generation unit is implemented, for example, by a specific processing unit 290 of the data processing apparatus 12 and generates a schedule based on information received by the reception unit. The listing unit is implemented, for example, by the control unit 46A of the headset-type terminal 314 and allows the user to take photographs of items to be sold, set an appropriate price by uploading them to a generation AI, and list them in a flea market. The quotation acquisition unit is implemented, for example, by the specific processing unit 290 of the data processing apparatus 12 and estimates the amount of moving luggage when the user inputs the quantity and obtains quotations from multiple moving companies. The image recognition unit is implemented, for example, by the control unit 46A of the headset-type terminal 314 and determines, using image recognition technology, whether furniture is compatible when the user uploads a floor plan of the new residence and photographs of furniture. The correspondence between each unit and the apparatus or control unit is not limited to the examples described above and various modifications are possible.

### Fourth Embodiment

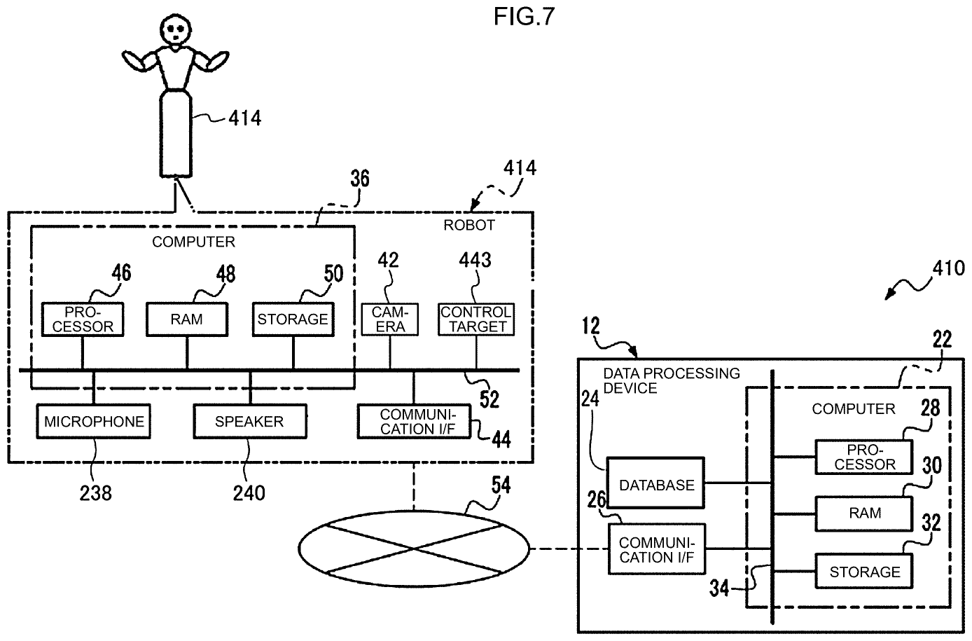

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

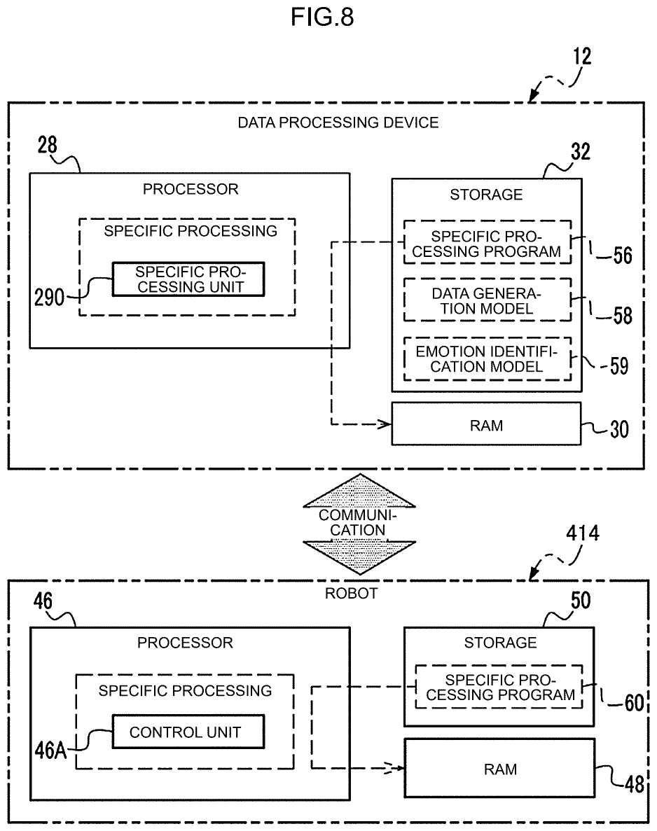

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the aforementioned reception unit, generation unit, listing unit, quotation acquisition unit, and image recognition unit is implemented, for example, by at least one of a robot 414 and a data processing apparatus 12. For example, the reception unit is implemented by a control unit 46A of the robot 414 and receives input of the user's new address or desired move-in date. The generation unit is implemented, for example, by a specific processing unit 290 of the data processing apparatus 12 and generates a schedule based on information received by the reception unit. The listing unit is implemented, for example, by the control unit 46A of the robot 414 and allows the user to take photographs of items to be sold, set an appropriate price by uploading them to a generation AI, and list them in a flea market. The quotation acquisition unit is implemented, for example, by the specific processing unit 290 of the data processing apparatus 12 and estimates the amount of moving luggage when the user inputs the quantity and obtains quotations from multiple moving companies. The image recognition unit is implemented, for example, by the control unit 46A of the robot 414 and determines, using image recognition technology, whether furniture is compatible when the user uploads a floor plan of the new residence and photographs of furniture. The correspondence between each unit and the apparatus or control unit is not limited to the examples described above and various modifications are possible.

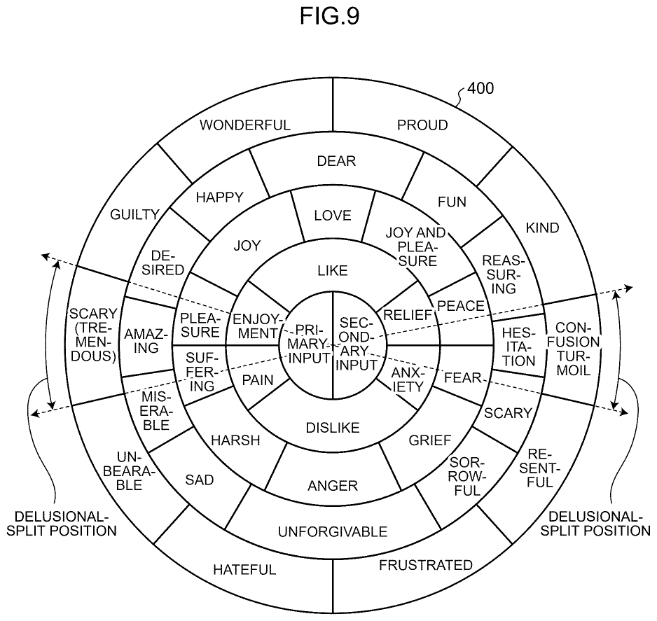

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

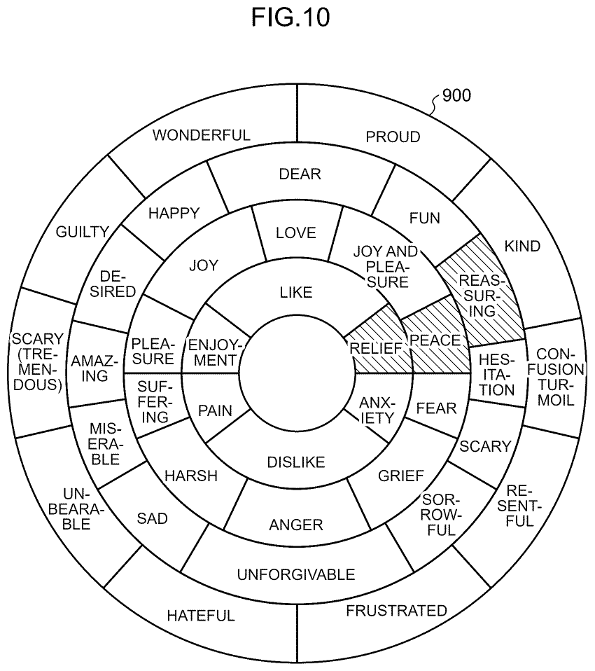

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

(Supplementary Note 1)A system comprising: a reception unit configured to receive input of a user's new address or desired move-in date; a generation unit configured to generate a schedule based on information received by the reception unit; a listing unit configured to allow the user to take photographs of items to be sold, set an appropriate price by uploading them to a generation algorithm, and list them in a flea market; a quotation acquisition unit configured to estimate the amount of moving luggage when the user inputs the quantity and obtain quotations from multiple moving companies; and an image recognition unit configured to determine, using image recognition technology, whether furniture is compatible when the user uploads a floor plan of the new residence and photographs of furniture.
(Supplementary Note 2)The system according to Supplementary Note 1, wherein the reception unit is configured to estimate the user's emotions and adjust the timing of input of the new address or desired move-in date based on the estimated emotions of the user.
(Supplementary Note 3)The system according to Supplementary Note 1, wherein the reception unit is configured to analyze the user's past moving history and select an optimal input method.
(Supplementary Note 4)The system according to Supplementary Note 1, wherein the reception unit is configured to perform filtering based on the user's current living situation or areas of interest when inputting the new address or desired move-in date.
(Supplementary Note 5)The system according to Supplementary Note 1, wherein the reception unit is configured to estimate the user's emotions and determine the priority of information to be input based on the estimated emotions of the user.
(Supplementary Note 6)The system according to Supplementary Note 1, wherein the reception unit is configured to preferentially input highly relevant information based on the user's geographic location information when inputting the new address or desired move-in date.
(Supplementary Note 7)The system according to Supplementary Note 1, wherein the reception unit is configured to analyze the user's social media activity and input related information when inputting the new address or desired move-in date.
(Supplementary Note 8)The system according to Supplementary Note 1, wherein the generation unit is configured to estimate the user's emotions and adjust the schedule generation method based on the estimated emotions of the user.
(Supplementary Note 9)The system according to Supplementary Note 1, wherein the generation unit is configured to adjust the level of detail of the schedule based on the importance of the move when generating the schedule.
(Supplementary Note 10)The system according to Supplementary Note 1, wherein the generation unit is configured to apply different generation algorithms according to the category of the move when generating the schedule.
(Supplementary Note 11)The system according to Supplementary Note 1, wherein the generation unit is configured to estimate the user's emotions and adjust the length of the schedule based on the estimated emotions of the user.
(Supplementary Note 12)The system according to Supplementary Note 1, wherein the generation unit is configured to determine the priority of the schedule based on the submission timing of the move when generating the schedule.
(Supplementary Note 13)The system according to Supplementary Note 1, wherein the generation unit is configured to adjust the order of the schedule based on the relevance of the move when generating the schedule.
(Supplementary Note 14)The system according to Supplementary Note 1, wherein the listing unit is configured to estimate the user's emotions and adjust the method of expressing the listing based on the estimated emotions of the user.
(Supplementary Note 15)The system according to Supplementary Note 1, wherein the listing unit is configured to adjust the level of detail of the listing based on the importance of the item when listing.
(Supplementary Note 16)The system according to Supplementary Note 1, wherein the listing unit is configured to apply different listing algorithms according to the category of the item when listing.
(Supplementary Note 17)The system according to Supplementary Note 1, wherein the listing unit is configured to estimate the user's emotions and adjust the length of the listing based on the estimated emotions of the user.
(Supplementary Note 18)The system according to Supplementary Note 1, wherein the listing unit is configured to determine the priority of the listing based on the submission timing of the item when listing.
(Supplementary Note 19)The system according to Supplementary Note 1, wherein the listing unit is configured to adjust the order of the listing based on the relevance of the item when listing.
(Supplementary Note 20)The system according to Supplementary Note 1, wherein the quotation acquisition unit is configured to estimate the user's emotions and adjust the method of obtaining quotations based on the estimated emotions of the user.
(Supplementary Note 21)The system according to Supplementary Note 1, wherein the quotation acquisition unit is configured to adjust the level of detail of the quotations based on the importance of the move when obtaining quotations.
(Supplementary Note 22)The system according to Supplementary Note 1, wherein the quotation acquisition unit is configured to apply different quotation algorithms according to the category of the move when obtaining quotations.
(Supplementary Note 23)The system according to Supplementary Note 1, wherein the quotation acquisition unit is configured to estimate the user's emotions and determine the priority of the quotations based on the estimated emotions of the user.
(Supplementary Note 24)The system according to Supplementary Note 1, wherein the quotation acquisition unit is configured to determine the priority of the quotations based on the submission timing of the move when obtaining quotations.
(Supplementary Note 25)The system according to Supplementary Note 1, wherein the quotation acquisition unit is configured to adjust the order of the quotations based on the relevance of the move when obtaining quotations.
(Supplementary Note 26)The system according to Supplementary Note 1, wherein the image recognition unit is configured to estimate the user's emotions and adjust the method of image recognition based on the estimated emotions of the user.
(Supplementary Note 27)The system according to Supplementary Note 1, wherein the image recognition unit is configured to adjust the level of detail of image recognition based on the importance of the furniture when performing image recognition.
(Supplementary Note 28)The system according to Supplementary Note 1, wherein the image recognition unit is configured to apply different image recognition algorithms according to the category of the furniture when performing image recognition.
(Supplementary Note 29)The system according to Supplementary Note 1, wherein the image recognition unit is configured to estimate the user's emotions and determine the priority of image recognition based on the estimated emotions of the user.
(Supplementary Note 30)The system according to Supplementary Note 1, wherein the image recognition unit is configured to determine the priority of image recognition based on the submission timing of the furniture when performing image recognition.
(Supplementary Note 31)The system according to Supplementary Note 1, wherein the image recognition unit is configured to adjust the order of image recognition based on the relevance of the furniture when performing image recognition.

What is claimed is:

1. A system comprising:
a communication interface configured to communicate with a client terminal via a packet-switched network;
a memory storing a data generation model obtained by deep learning on a neural network, and an emotion identification model; and
circuitry configured to:
receive, from the client terminal via the communication interface, structured input data comprising at least one of location data or temporal data;
generate, using the data generation model comprising a Transformer-based large language model, schedule data based on the structured input data, the schedule data comprising task identifiers and associated temporal values output in a structured data format;
receive, from the client terminal via the communication interface, first image data captured by a camera of the client terminal;
extract, using an image classification model comprising a convolutional neural network, first feature vectors from the first image data;
generate, using the data generation model, inference data comprising a numerical score based on the first feature vectors and text data received from the client terminal;
receive, from the client terminal via the communication interface, second image data comprising floor plan image data and object image data;
extract, using an object detection model comprising a convolutional neural network, spatial feature vectors from the floor plan image data and object feature vectors from the object image data;
generate, using the data generation model, a compatibility determination and recommendation text based on a spatial alignment comparison of the spatial feature vectors and the object feature vectors; and
transmit the schedule data, the inference data, and the compatibility determination to the client terminal via the communication interface and the packet-switched network.

2. The system according to claim 1, wherein the location data comprises address data including at least one of a postal code, a building name, or a room number, and wherein the temporal data comprises a date value in ISO8601 format.

3. The system according to claim 1, wherein the schedule data is output in at least one of a CSV format or a JSON array format, and wherein each task identifier is associated with at least one of a date value, a person-in-charge identifier, or a required time value.

4. The system according to claim 1, wherein the circuitry is further configured to prioritize tasks and adjust the schedule data using shortest path search algorithms comprising at least one of Dijkstra's algorithm or A* search.

5. The system according to claim 1, wherein the circuitry is further configured to extract, from the first image data, multimodal feature vectors using the convolutional neural network for image features and a text encoder for text features, and to generate the numerical score via a fully connected layer based on the multimodal feature vectors.

6. The system according to claim 1, wherein the object detection model comprises a YOLO-based model or a Vision Transformer, and wherein the spatial alignment comparison comprises at least one of an image registration algorithm or an intersection-over-union calculation.

7. The system according to claim 1, wherein the circuitry is further configured to estimate an emotion of the user by applying the emotion identification model to at least one of voice data, a face image, text input, or biometric sensor data received from the client terminal, and to adjust a timing of receiving the structured input data based on the estimated emotion.

8. The system according to claim 7, wherein the circuitry is further configured to adjust a level of detail of the schedule data based on the estimated emotion, such that when the estimated emotion indicates stress, the circuitry generates simplified schedule data comprising only main tasks, and when the estimated emotion indicates relaxation, the circuitry generates detailed schedule data comprising subtasks.

9. The system according to claim 7, wherein the circuitry is further configured to adjust a method of expressing the inference data based on the estimated emotion, such that when the estimated emotion indicates stress, the inference data is generated in a simplified expression style, and when the estimated emotion indicates relaxation, the inference data is generated in a detailed expression style.

10. The system according to claim 1, wherein the circuitry is further configured to analyze past history data stored in a database associated with the user and select an optimal input method for the structured input data using at least one of a decision tree, a random forest, or a reinforcement learning model.

11. The system according to claim 1, wherein the circuitry is further configured to perform filtering on the structured input data based on at least one of a current living condition or an area of interest of the user, the filtering comprising scoring candidates using a neural network or gradient boosting tree.

12. The system according to claim 1, wherein the circuitry is further configured to receive geographic location information from the client terminal via the communication interface, and to preferentially process structured input data associated with a geographic region corresponding to the geographic location information.

13. The system according to claim 1, wherein the circuitry is further configured to receive social media activity data from the client terminal via the communication interface, extract area interest information from the social media activity data using a natural language processing model, and adjust the schedule data based on the extracted area interest information.

14. The system according to claim 1, wherein the circuitry is further configured to adjust a level of detail of the schedule data based on an importance score associated with each task, such that for tasks having a high importance score, the circuitry generates detailed schedule data comprising subtask breakdown and required time estimation, and for tasks having a low importance score, the circuitry generates simplified schedule data.

15. The system according to claim 1, wherein the circuitry is further configured to apply different generation algorithms according to a category of the structured input data, such that for a first category, the circuitry applies a constraint satisfaction problem solver, and for a second category, the circuitry applies a multi-objective optimization algorithm.

16. The system according to claim 1, wherein the circuitry is further configured to determine a priority of generating the schedule data based on a submission timing associated with the structured input data, such that structured input data having a more recent submission timing is processed with a higher priority.

17. The system according to claim 1, wherein the circuitry is further configured to analyze dependencies between tasks using a graph neural network or a Transformer-based model, and to adjust an order of the schedule data based on relevance scores calculated from the dependencies.

18. A system comprising:
a communication interface configured to communicate, via a packet-switched network conforming to at least one of a 5G, Wi-Fi, or Bluetooth communication standard, with a client terminal comprising a touch panel, a microphone, a speaker, a camera having a CMOS image sensor, and a display;
a processor;
a random-access memory;
a memory storing a data generation model obtained by deep learning on a neural network, and an emotion identification model;
a database; and
circuitry configured to:
receive, from the client terminal via the communication interface, structured input data comprising at least one of location data or temporal data;
generate, using the data generation model comprising a Transformer-based large language model, schedule data based on the structured input data;
receive, from the client terminal via the communication interface, first image data captured by the camera having the CMOS image sensor;
extract, using an image classification model comprising a convolutional neural network, first feature vectors from the first image data, and generate inference data comprising a numerical score based on the first feature vectors and text data;
estimate an emotion of the user by applying the emotion identification model to at least one of voice data captured by the microphone or image data captured by the camera;
receive, from the client terminal via the communication interface, second image data comprising floor plan image data and object image data;
extract, using an object detection model, spatial feature vectors from the floor plan image data and object feature vectors from the object image data, and generate a compatibility determination based on a spatial alignment comparison; and
transmit the schedule data, the inference data, and the compatibility determination to the client terminal via the communication interface, causing the client terminal to present output data to the user via at least one of the display or the speaker.

19. The system according to claim 18, wherein the data generation model comprises at least one of a text generation AI, an image generation AI, or a multimodal generation AI, and wherein the data generation model is a fine-tuned model configured to output inference results from prompts without instructions.

20. A method performed by circuitry of a system comprising a communication interface, a memory storing a data generation model obtained by deep learning on a neural network and an emotion identification model, the method comprising:
receiving, from a client terminal via the communication interface and a packet-switched network, structured input data comprising at least one of location data or temporal data;
generating, using the data generation model comprising a Transformer-based large language model, schedule data based on the structured input data, the schedule data comprising task identifiers and associated temporal values;
receiving, from the client terminal via the communication interface, first image data captured by a camera of the client terminal;
extracting, using an image classification model comprising a convolutional neural network, first feature vectors from the first image data;
generating, using the data generation model, inference data comprising a numerical score based on the first feature vectors and text data received from the client terminal;
receiving, from the client terminal via the communication interface, second image data comprising floor plan image data and object image data;
extracting, using an object detection model comprising a convolutional neural network, spatial feature vectors from the floor plan image data and object feature vectors from the object image data;
generating, using the data generation model, a compatibility determination and recommendation text based on a spatial alignment comparison of the spatial feature vectors and the object feature vectors; and
transmitting the schedule data, the inference data, and the compatibility determination to the client terminal via the communication interface and the packet-switched network.
